(19) United States
(12) Patent Application Publication
(10) Pub. No.: US 2004/0225664 A1
(43) Pub. Date: Nov. 11, 2004

(54) Data abstraction layer and automated data staging system and method

(76) Inventor: Richard Allen Casement, Elk River, MN (US)

Correspondence Address: Beck & Tysver, P.L.L.C., Suite 100, 2900 Thomas Avenue S., Minneapolis, MN, 55416, US

(21) Appl. No.: 10/654,691

(22) Filed: Sep. 4, 2003

Related U.S. Application Data
(60) Provisional application No. 60/408,082, filed on Sep. 4, 2002.

(51) Int. Cl. G06F 7/00

(52) U.S. Cl. 707/100

(57) ABSTRACT

A data staging system and data abstraction layer aid in reconciling multiple data sources.

This application claims priority to U.S. Ser. No. 60/408082, filed Sep. 4, 2002.

### FIELD OF THE INVENTION

The present invention relates generally to a data staging system and method for collecting, storing and presenting product and enterprise information and to a data abstraction layer for reconciling vendor-supplied item identifiers with the enterprise's SKUs and provides integration between SKUs, content and images.

### BACKGROUND OF THE INVENTION

A typical retail enterprise uses data systems for many aspects of its operations: inventory management, product catalog management (for supplying product data, order management system to take and track orders in an online store and the like. Typically, an enterprise's data storage system and data processes grow with the enterprise in a somewhat ad hoc fashion, with components of data systems built independently and later linked to one another. It has been typical practice for an enterprise to replicate its entire data system for each brand, as brands are acquired and for these separate data systems to not work together or to have limited ability to work together. It is further typical practice for an enterprise to have a need to exchange data with third parties, such as vendors or “fulfillment partners”. As a result, an enterprise may have a system architecture that is not universally integrated. Adding a product to the enterprise's offerings would typically require considerably manual attention to the data for that product.

Data staging is the process of preparing data from one system for use by another. Data staging typically involves bringing data into a system, cleaning it, combining it, archiving it and eventually exporting it to another system or application that makes use of or presents the data to an end user. End users may be “internal” to a business enterprise, such as product managers or retail store workers, or “external”, such as online customers of the business enterprise.

Data staging is particularly important where raw data comes to the staging area from different sources or in different forms. To give a simple example, name information arrives from one data source where separate fields are defined for the first name and the last name. From a second data source, first and last names are presented in a single field. To coordinate these two disparate formats to achieve one consistent database, the raw data from the two databases must be processed. Several options are available for this simple example: An operation can be performed on the data from the first source to add or combine the first and last name fields to “calculate” a new whole-name fields that would be consistent with the format from the second source. Alternatively, the name data from the second database could be processed to divide the first and last names into separate fields. While this example is simple, the task of processing data to achieve consistency can be enormously complex when it involves a large quantity of data from multiple sources with great degrees of variation. The task is further complicated when the data is dynamic, i.e. frequently or constantly changing or is added to or deleted from frequently or on an ongoing basis. With large amounts of data or with dynamic data, it is particularly important that the staging system and method be automated so that the data is quickly incorporated into the system for timely access by users. This is the case with a data system that manages product information where products and information about the products comes from a variety of sources and where the products are sold through multiple business entities and through multiple channels of trade (e.g. bricks and mortar, internet).

Data management is a crucial function of any retail sales operation, but is of particular import for an enterprise that sells products via physical stores, i.e. “bricks and mortar” and via the Internet. Products come from a variety of sources, and information about the products, their inventory and promotions offered by the enterprise or by the business entities must be controlled in a flexible manner and made available in a timely manner to all those who can use the product information, both for internal management purposes and for customers use. In many cases, it is desirable to make the information consistent; in other cases, it may be desirable to vary information by geographic region or by business entity or channels of trade, such as to reflect inventory variations or to offer targeted promotions.

It is desirable for each product in an enterprise's database to have a unique identifier. This is typically accomplished with a Stock Keeping Unit or “SKU” number that is unique to each product or service. (Throughout this application, “product” shall mean both products and services.) Where an enterprise encompasses multiple business entities, it is difficult to use the SKU numbers assigned by each business entity because it is possible that the same SKU was used by different business entities to designate different products. Further, the individual business entities may not use the same data format for their SKUs; for example, an entity may use a nine digit number for an SKU, while another might use a six digit number or a combination of letters and numbers or a hyphenated format. To coordinate the SKU lists of the two entities requires generation of a new item identifier (“item ID”) that is unique to each product without having more than one identifier for a single product (although the product may be sold by more than one business entity).

### SUMMARY OF THE INVENTION

The system and method of the present invention stages data from various sources and performs an automated series of steps on the data to assimilate it into a master SKU table and to make it useable for and available to other applications, including systems for making the information available to a web site hosting an online store. The system includes the use of an abstraction layer to reconcile item identifiers between and amongst various data sources.

### BRIEF DESCRIPTION OF THE DRAWINGS

An exemplary version of a a data staging and abstraction layer system? is shown in the figures wherein like reference numerals refer to equivalent structure throughout, and wherein:

FIG. 1 is MABL Logical Function Topology;

FIG. 3 is MABL High-Level Core Architecture;

FIG. 4 is MABL High-Level ODS Data Flow;

FIG. 5 is MABL Core Table Structure Layout;

FIG. 6 is MABL Core Table Structure With Data Example;

FIG. 7 is MABL Key Structure Example;

FIG. 8 is An Example SKU Master Structure Without MABL;

FIG. 9 is An Example SKU Master Structure Using MABL;

FIG. 10 is A MABL SKU Build Process High-Level Data Flow

FIGS. 11-35 are Example screen shots of the Business Operations Portal (BOP) MABL User Interface;

FIG. 36 is A MABL SKU Creation/Modification Process States Diagram;

FIG. 37 is MABL End-to-end Data Flow Architecture;

FIG. 38 is The MABL Process States Flag for SKU Update Process

FIG. 39 is The MABL Process States Flag for SKU Creation Process

FIG. 40 is obsolete and should be dropped

FIG. 41 is The BOP Process States Flag for SKU Shipping Updates Process

FIG. 42 is The BOP Process States Flag for Manufacture Advertised Price Establishment Process

FIG. 43 is The BOP Process States Flag for Availability Messaging Process

FIG. 44 is The BOP Process States Flag for SKU Attribute Values Update Process.

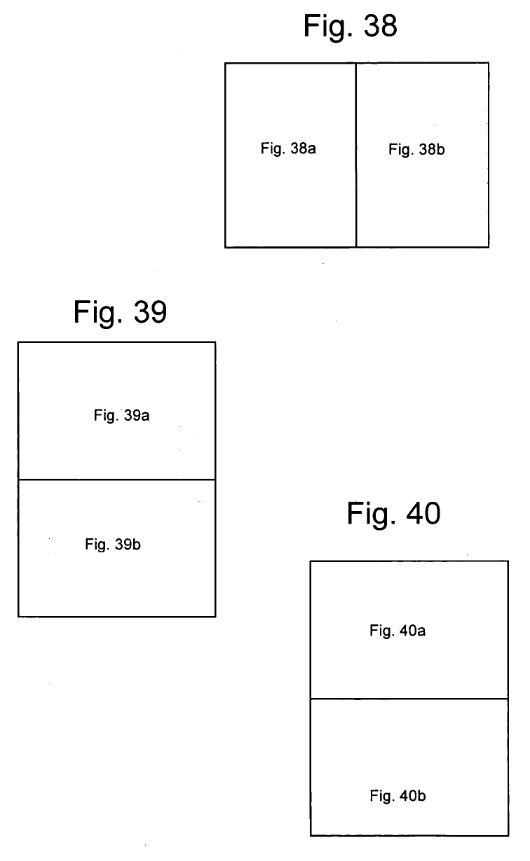

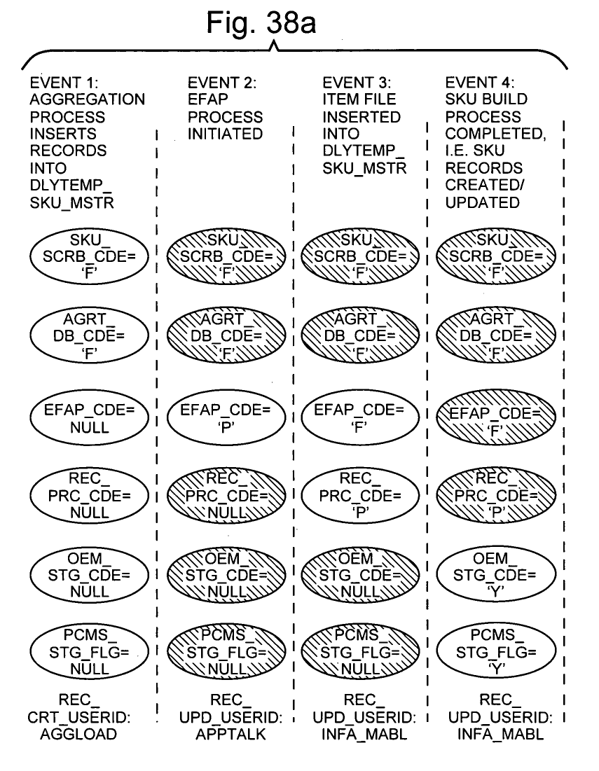

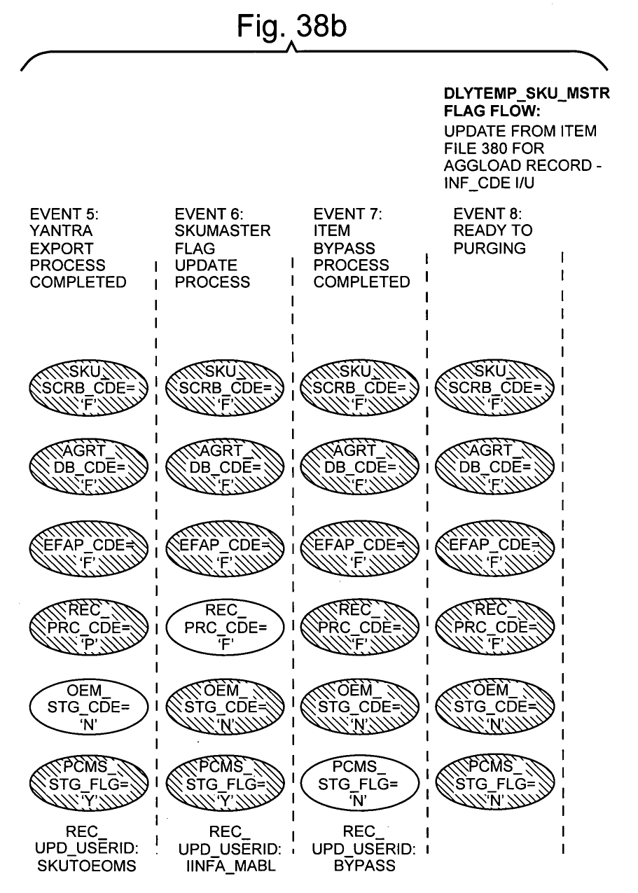

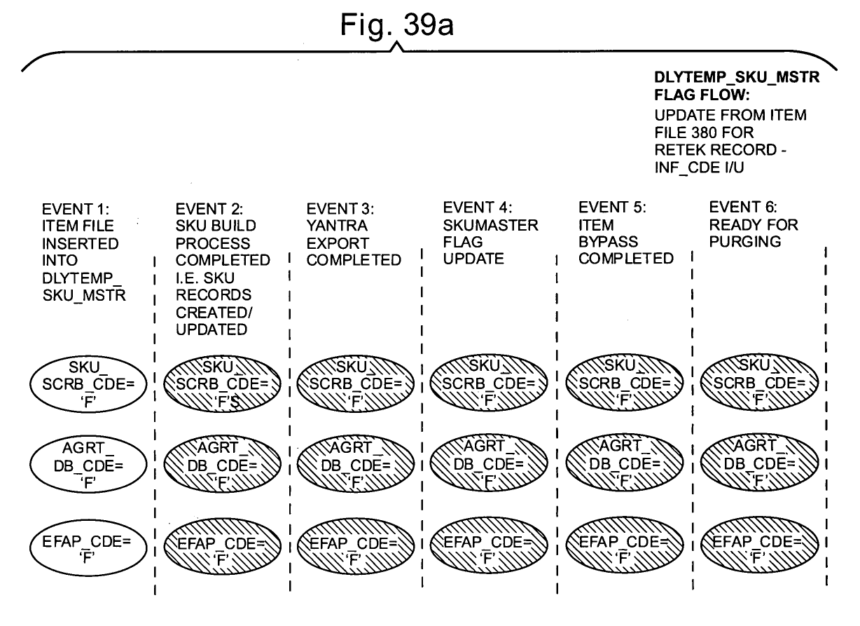

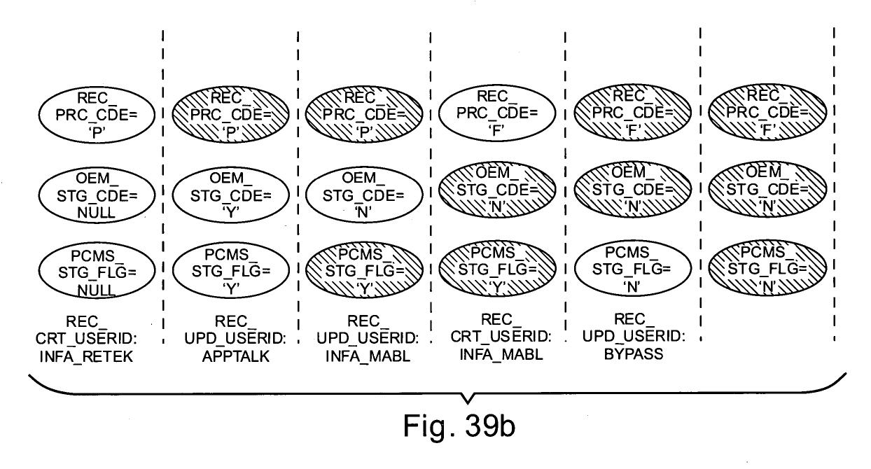

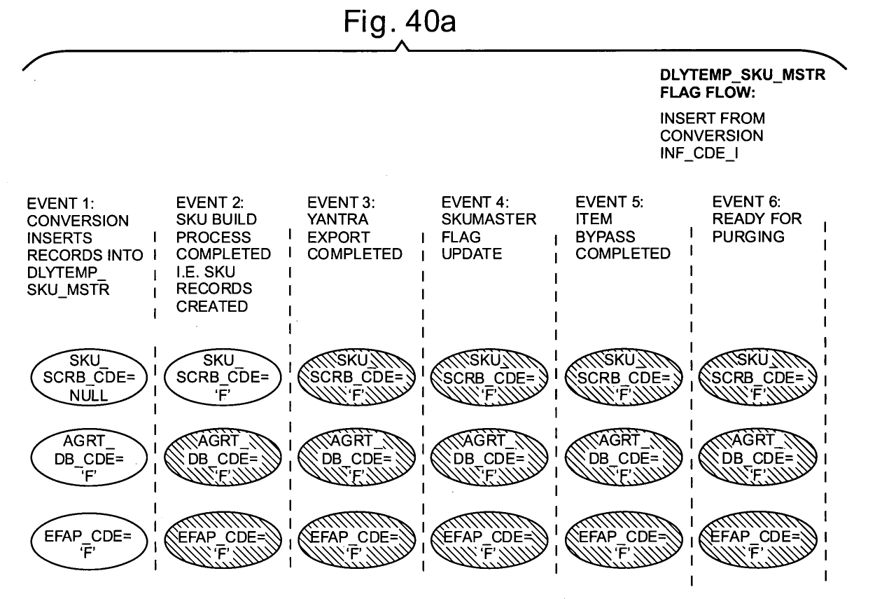

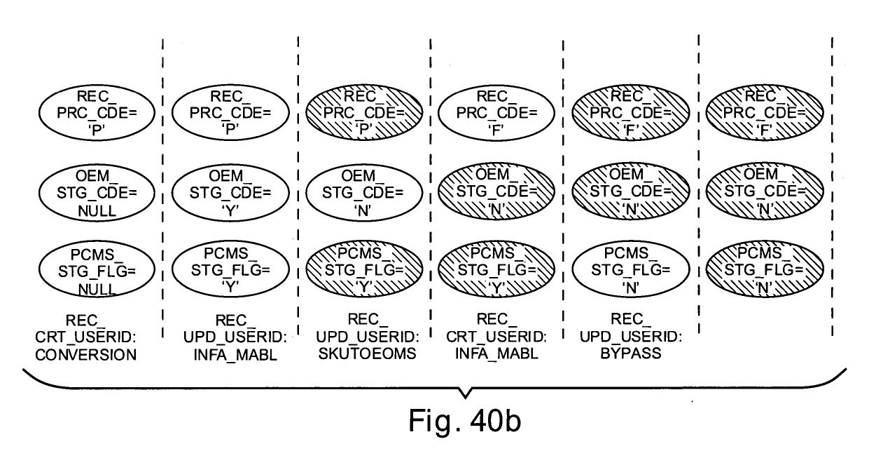

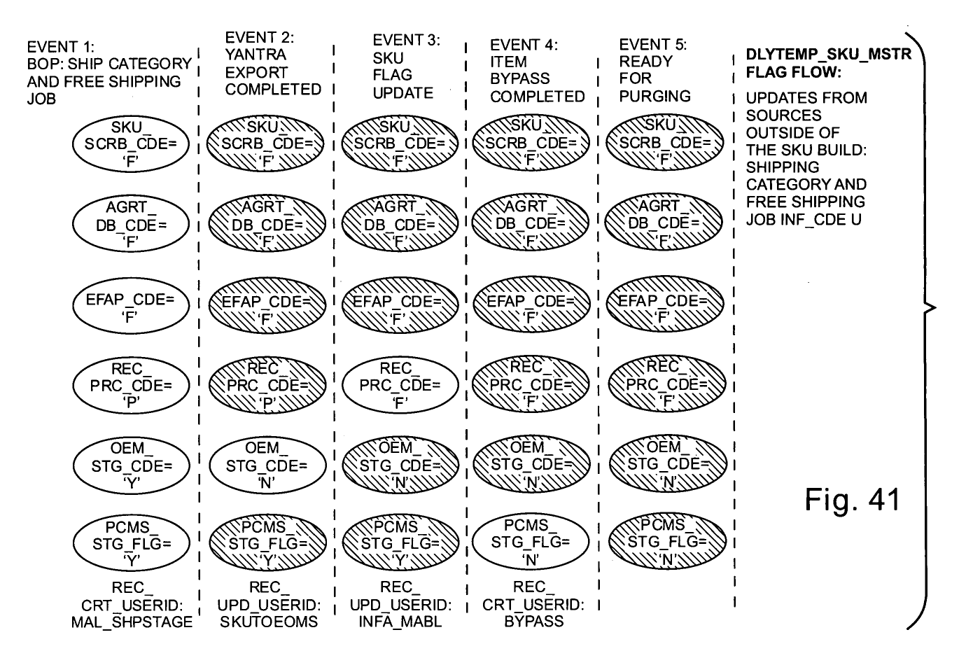

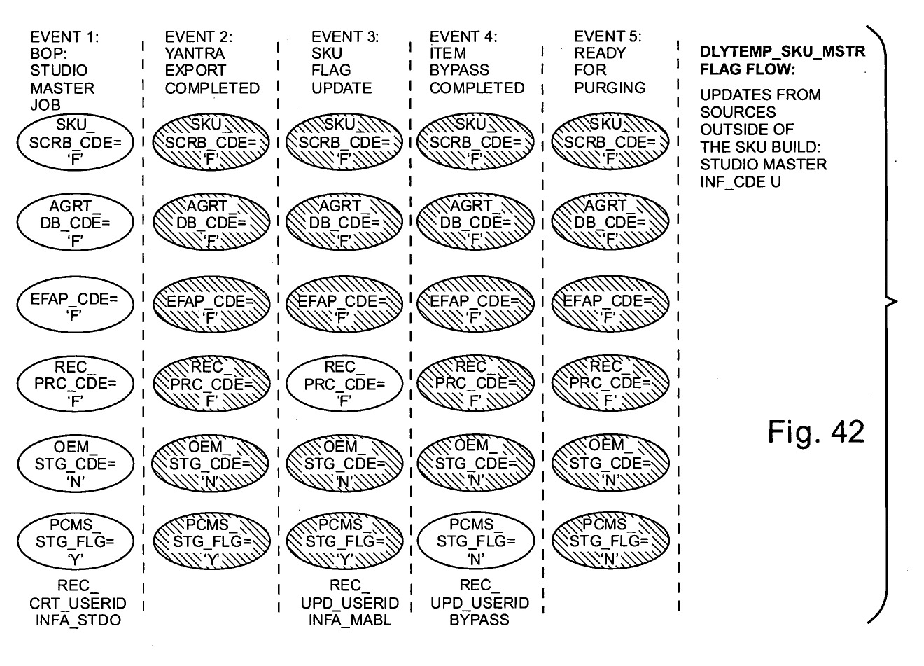

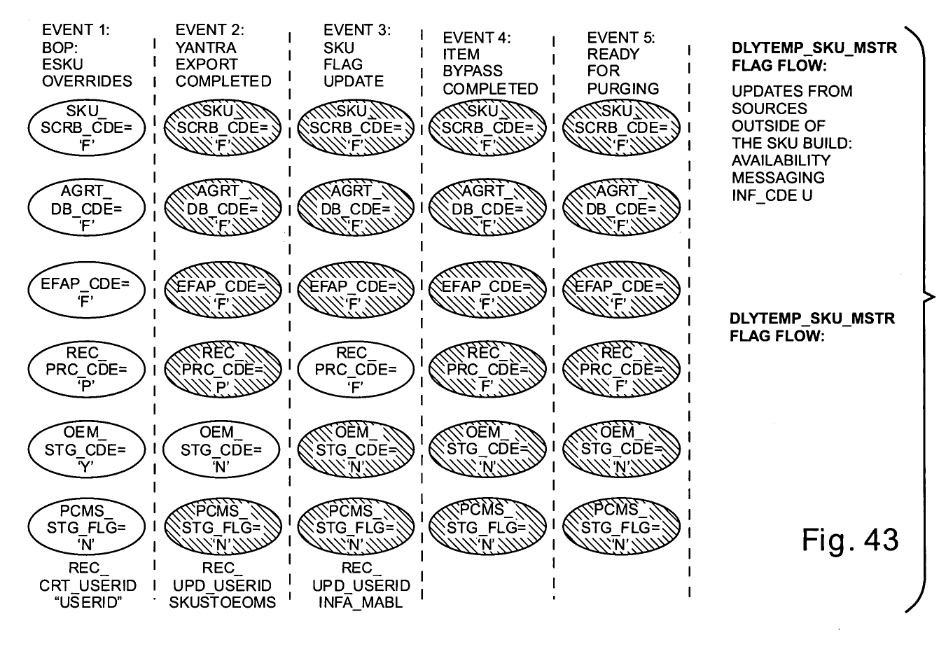

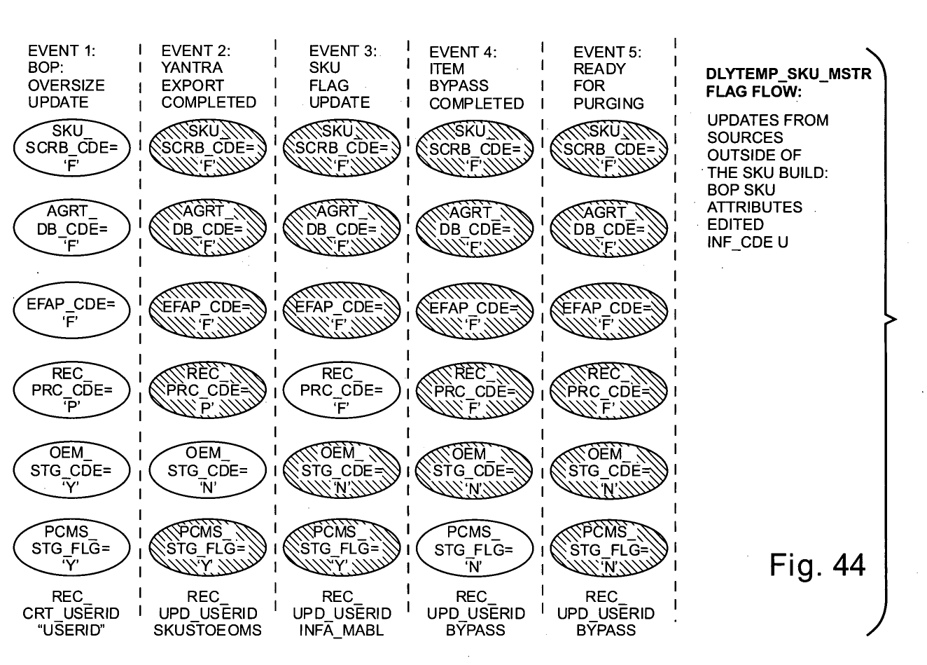

FIGS. 38-45 are.

### DETAILED DESCRIPTION OF THE PREFERRED EMBODIMENT(S)

The staging system and abstraction layer are advantageously applied in the context of an enterprise engaged in retail sales of products and services to customers, where the enterprise is composed of more than one “brand”, i.e. company or subsidiary. For example, Best Buy, Inc. is an enterprise which owns several brands: e.g. BestBuy.com, Inc., an online store designed to accommodate a worldwide presence; Futureshop, Inc., having a chain of physical stores selling consumer electronics, music, video, and games, primarily in Canada; and Best Buy retail stores. As noted, these brands sell their products through different “channels” of trade, including through physical store sites and through an online store on the Internet. The enterprise sells products, services and contracts for services; the terms “items” and “products” are used interchangeably and encompass all things sold by the enterprise.

The data staging system and the abstraction layer are designed to reconcile disparate systems in an automated fashion, particularly with respect to the assignment of a unique product identifier. The following is a key for some of the named systems described herein:

RETEK—an inventory management system;

YANTRA—an order management system;

PCMS—a product catalog management and presentation system preview of Internet site;

CSEE—a content server; and

ATG—Internet site product catalog management and presentation system.

While these are mentioned by tradename in places in this description and in the figures, it will be understood that analogous systems may be used in place of these named systems.

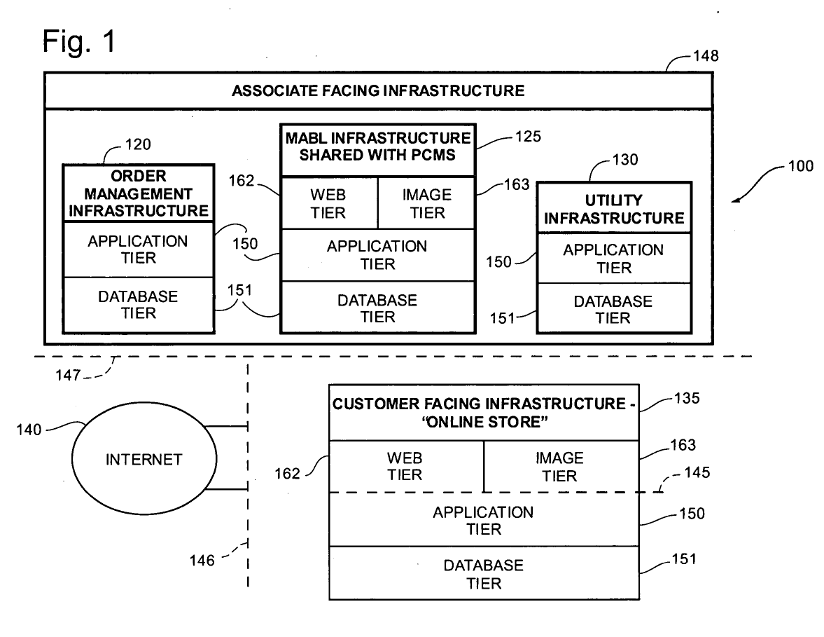

FIG. 1 represents technical infrastructure 100 to support a retail operation having a customer interface, such as an “online store”. The technical infrastructure 100 includes several infrastructure components: an order management infrastructure component 120; a multi-abstraction layer (MABL) infrastructure component 125; a utility infrastructure component 130; a customer facing infrastructure component or “online store” 135. These infrastructure components 120, 125, 130 and 135 cooperate to support a web site on the internet 140 that is accessible to the public and from which customers can shop (i.e. view products and information about products; purchase products for pick-up at a retail store location or for shipment to the customer). Dividing the technical infrastructure 100 into these components 120, 125, 130, 135 enhances performance and security control, which is of particular importance with a large web site.

The order management infrastructure component 120 facilitates product sourcing and inventory management and control. The MABL infrastructure component 125 stages data and reconciles vendor-supplied item identifiers with the enterprise's SKU's and integrates SKUs, content and images relating to products for sale. The utility infrastructure component 130 performs a variety of support functions, such as calculate tax on website orders based on customer order shipping location, provide credit authorization for customer orders, supplies customers with closest store to them based on zipcode. The customer facing infrastructure component 135 supports an online store.

The MABL infrastructure component 125 and the utility infrastructure component 130 cooperate to form an associate facing infrastructure 148 which is divided from the customer facing infrastructure 135 by firewall 145. The associate facing infrastructure 148 supports the application and databases required for systems whose primary users are employees of the business enterprise or its affiliates. The customer facing infrastructure 135 is used to support applications and databases required for systems whose primary users are customers of the business enterprise. Additional firewalls 146, 147 safeguard the system for external and internal intrusion. Through the firewalls, all elements of the infrastructure 110 are connected and can exchange data and rely on other systems to provide functionality. The order management infrastructure component 120, is primarily a customer-facing application that is protected behind firewall 147.

Each of the infrastructure components 120, 125, 130, 135 includes an application tier 150 [160, 170, 180, respectively] and a database tier 151 [161, 171, and 181, respectively]. The application tier stores application code to run MABL and other applications. Within the application tier, there are two servers running ATG® software on which Business Operations Portal (BOP), product Catalog management System (PCMS), MABL Core, Marketers Control Center (MCC), and the Site Preview application are built. This infrastructure is preferably shared for cost reasons. There are also two Informatica® application servers that provide data transformation functionality to MABL. Informatica® is software developed to be highly efficient at transforming data from one state to another. This software is often used during the processes described with respect to MABL processing flows, discussed below. The database tier 151 [161, 171 and 181] manages the data transformed through MABL processing. The applications tier 150 and the database tier 151 preferably deploy pairs of servers in “clustered” mode to achieve higher levels of robustness. Should one server of the pair fail, the other server will automatically pick up the load.

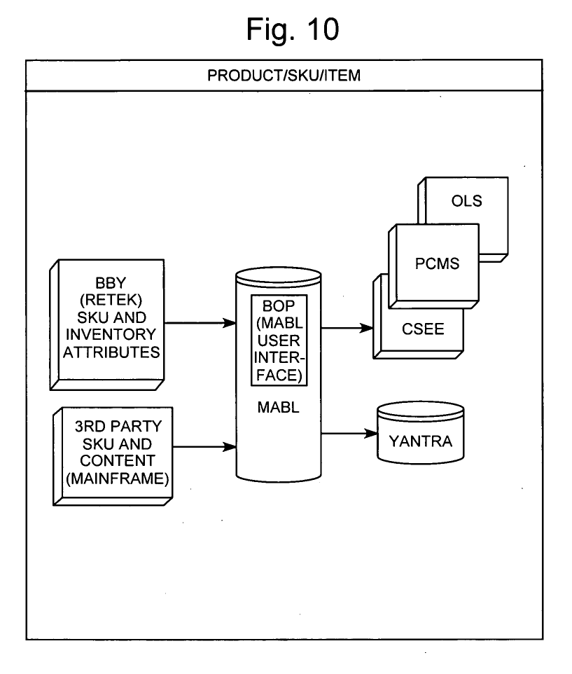

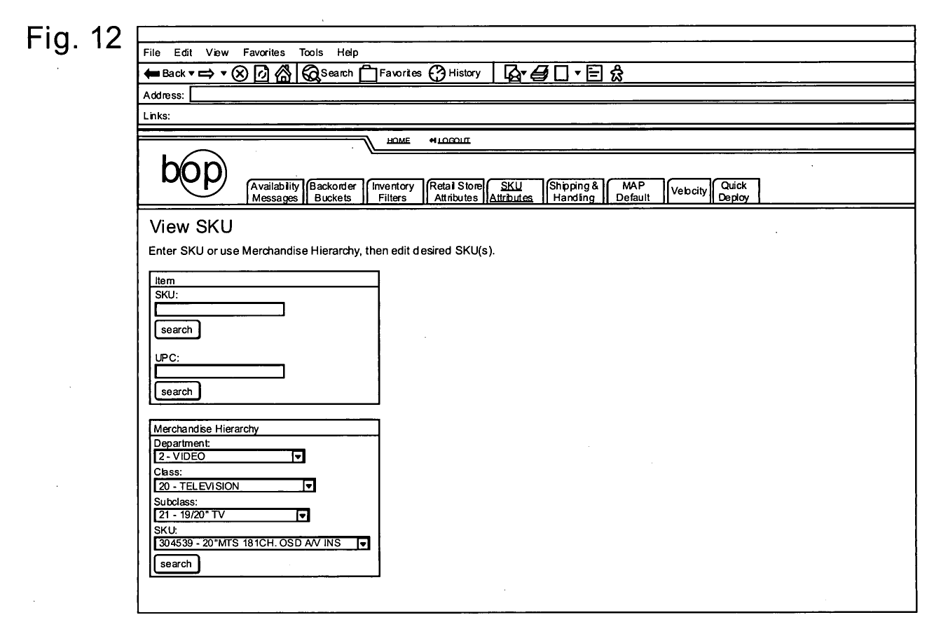

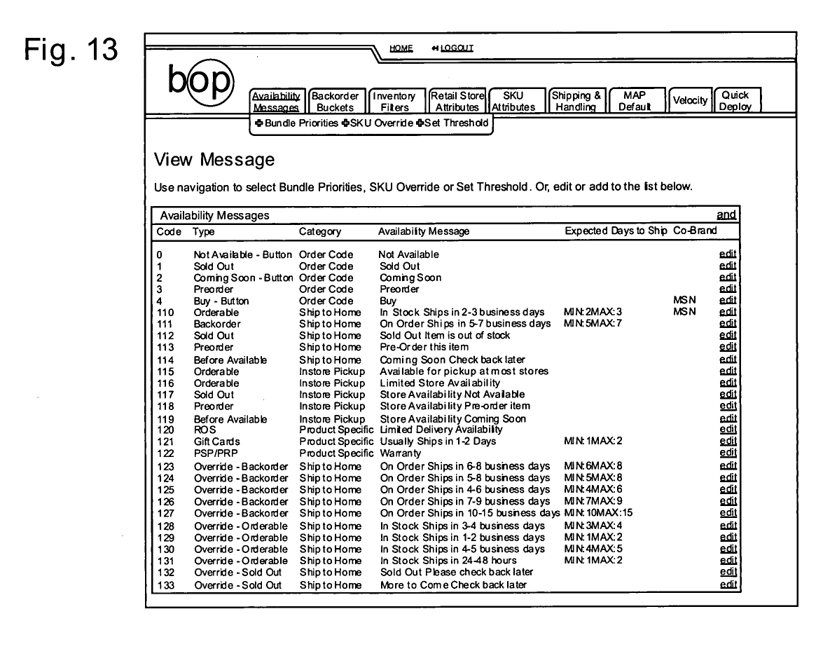

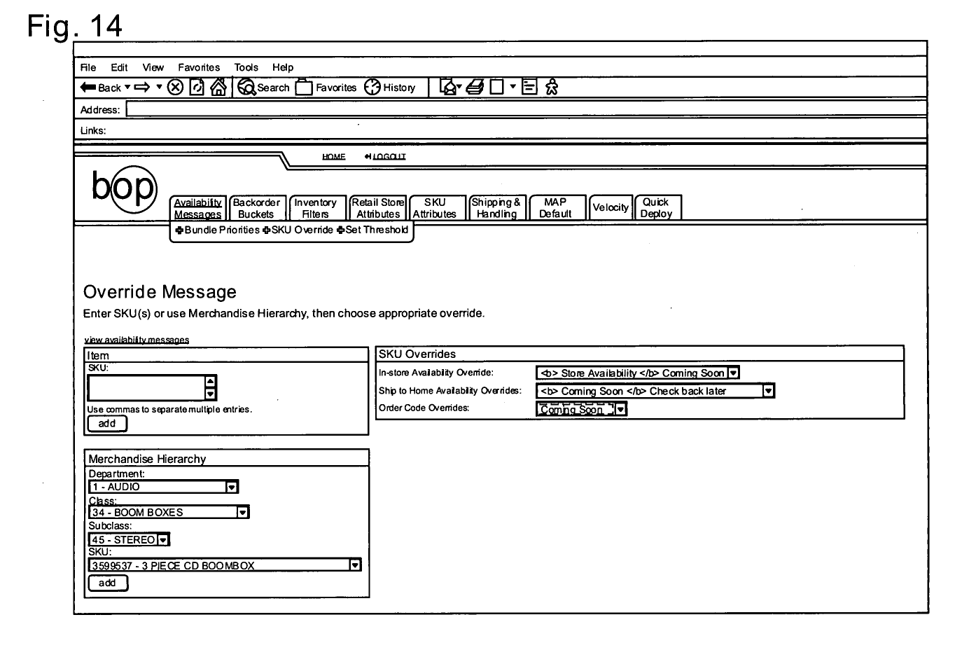

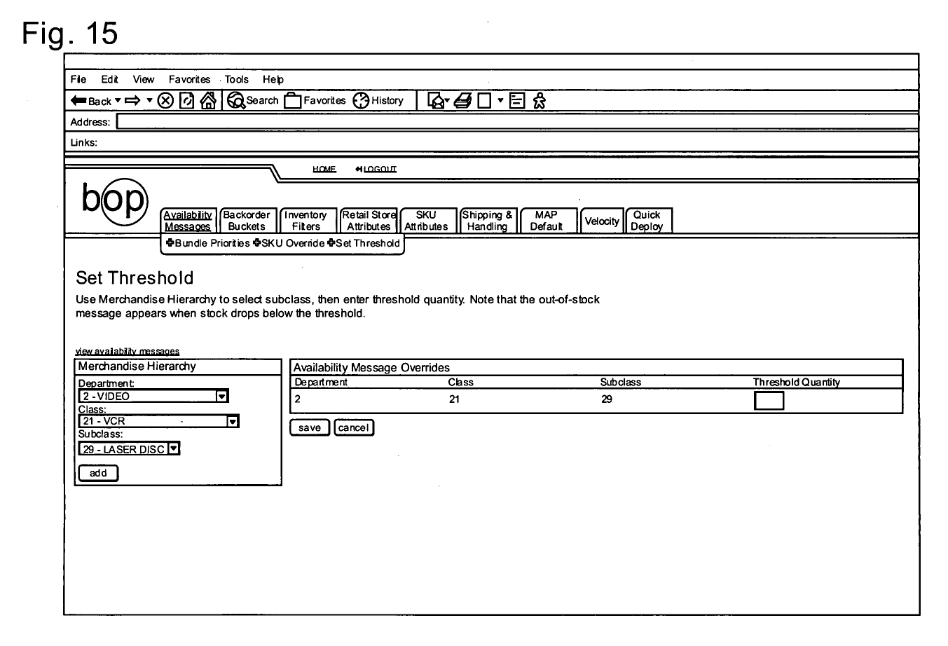

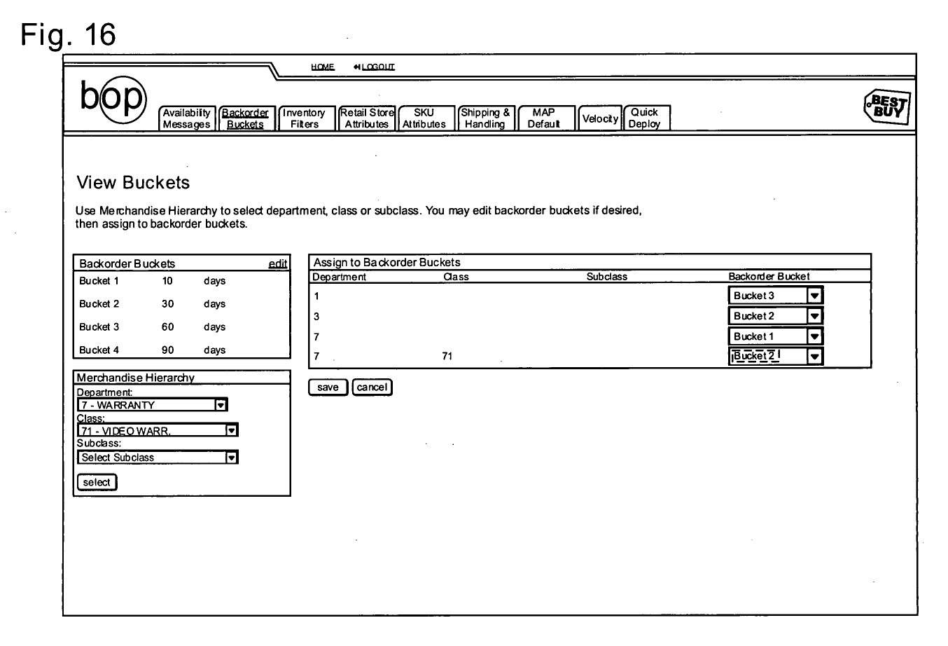

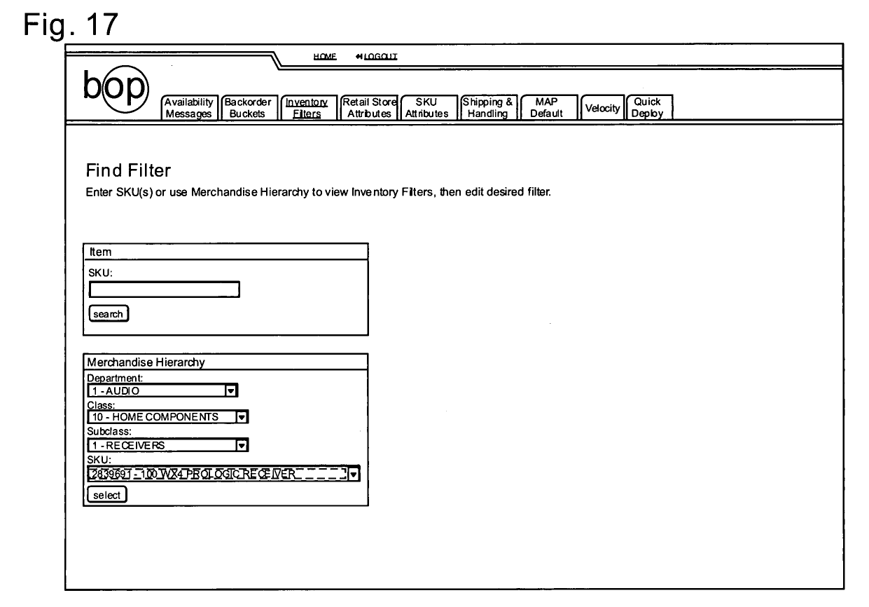

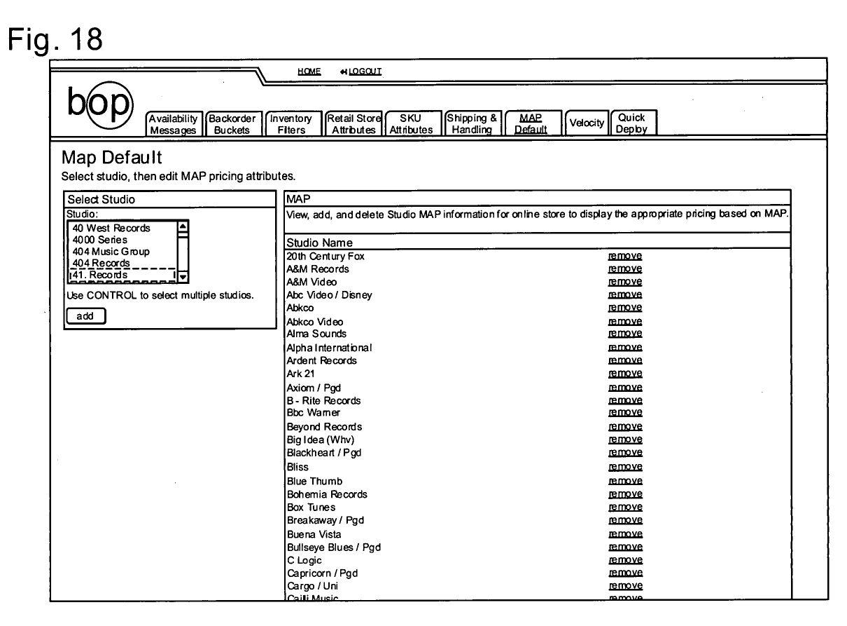

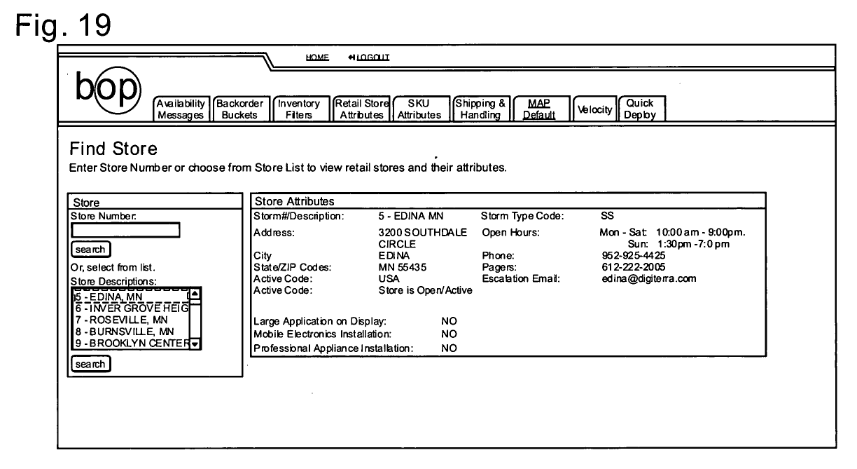

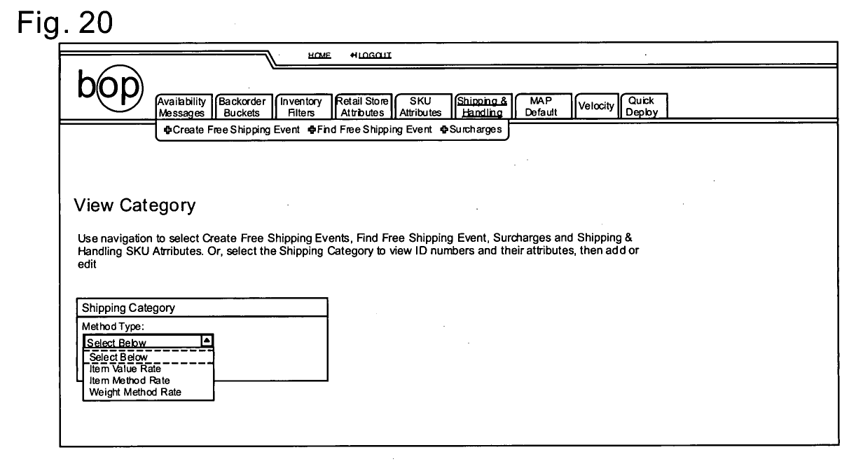

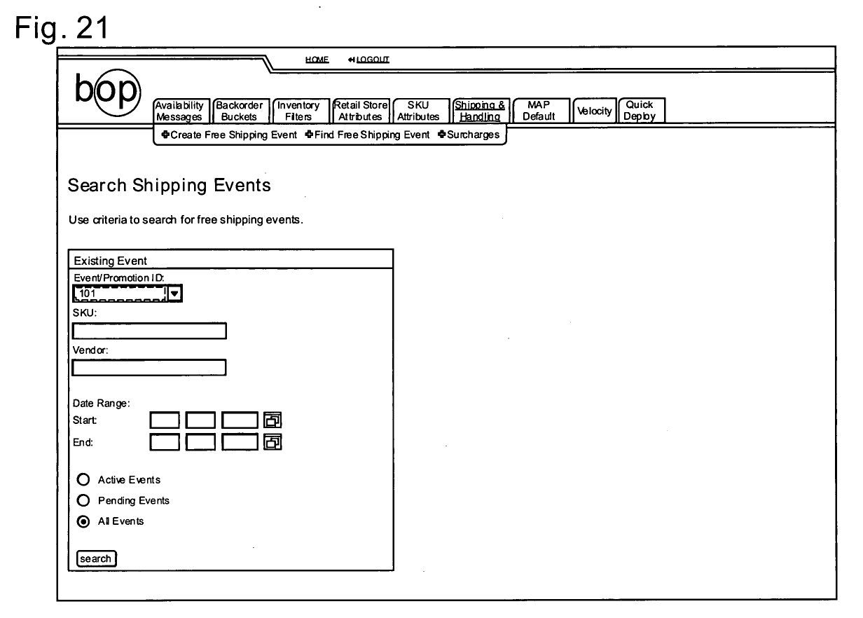

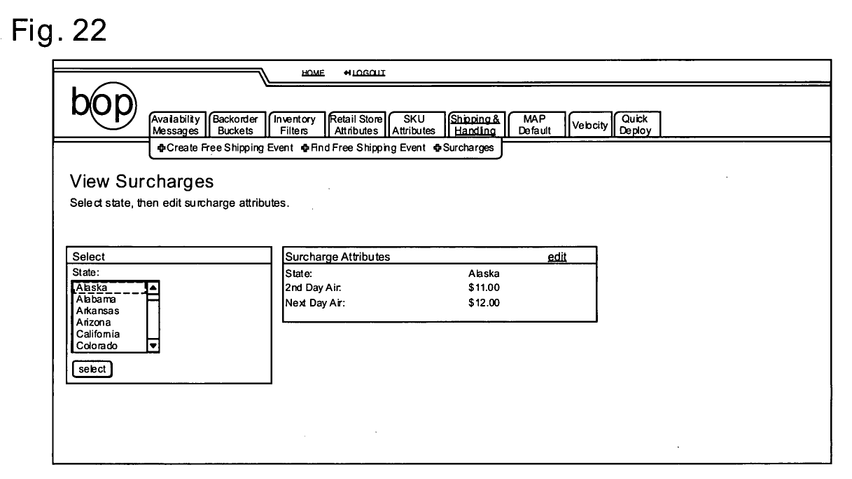

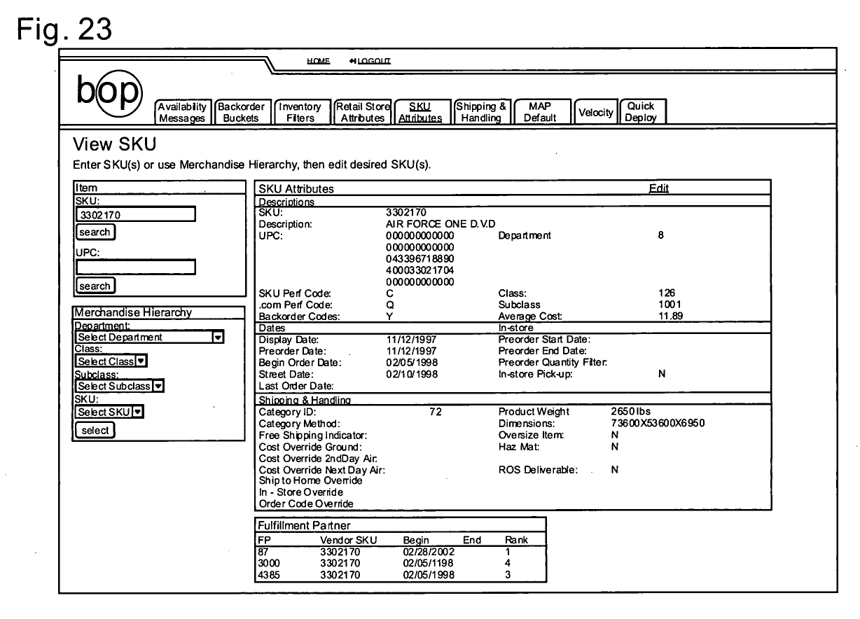

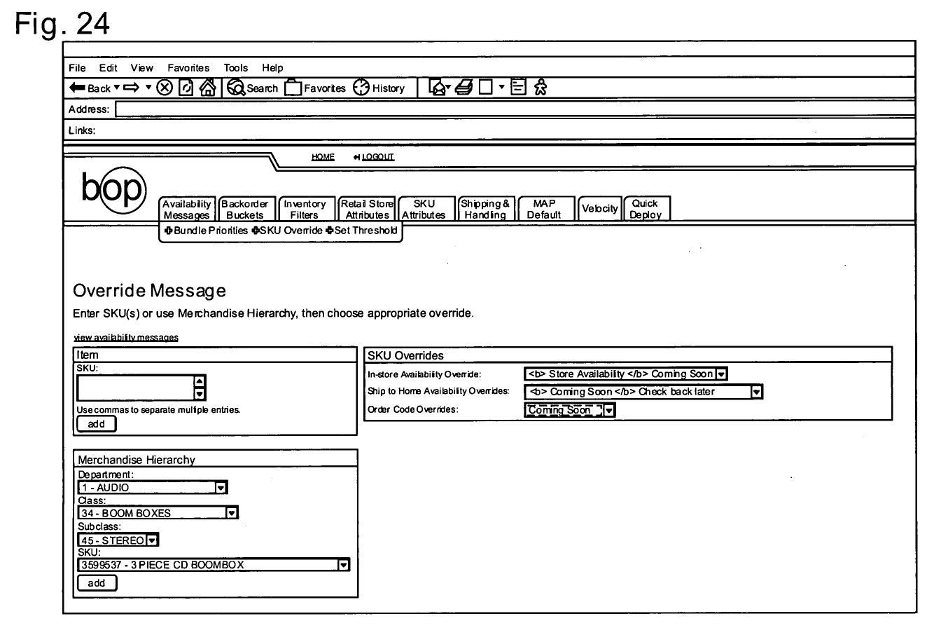

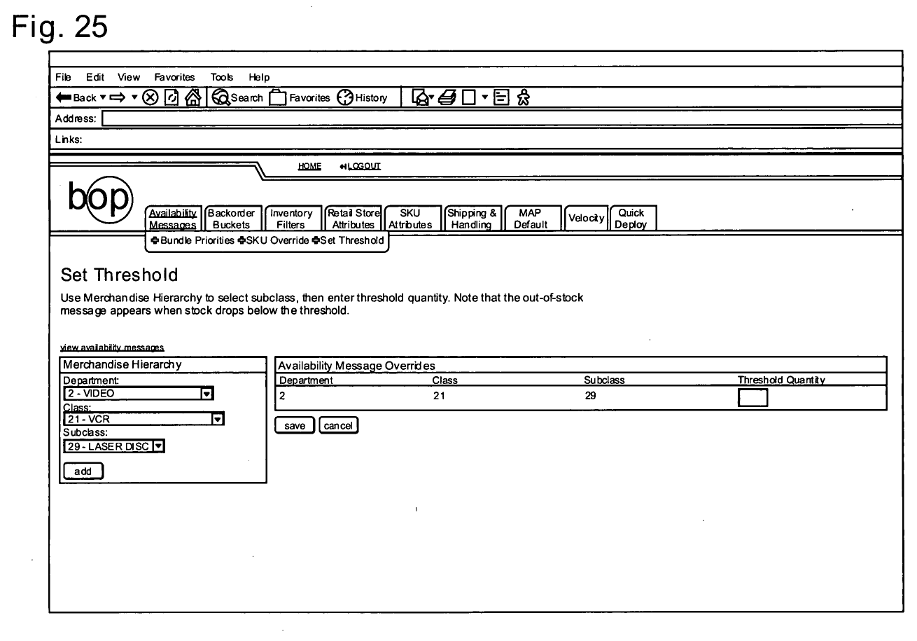

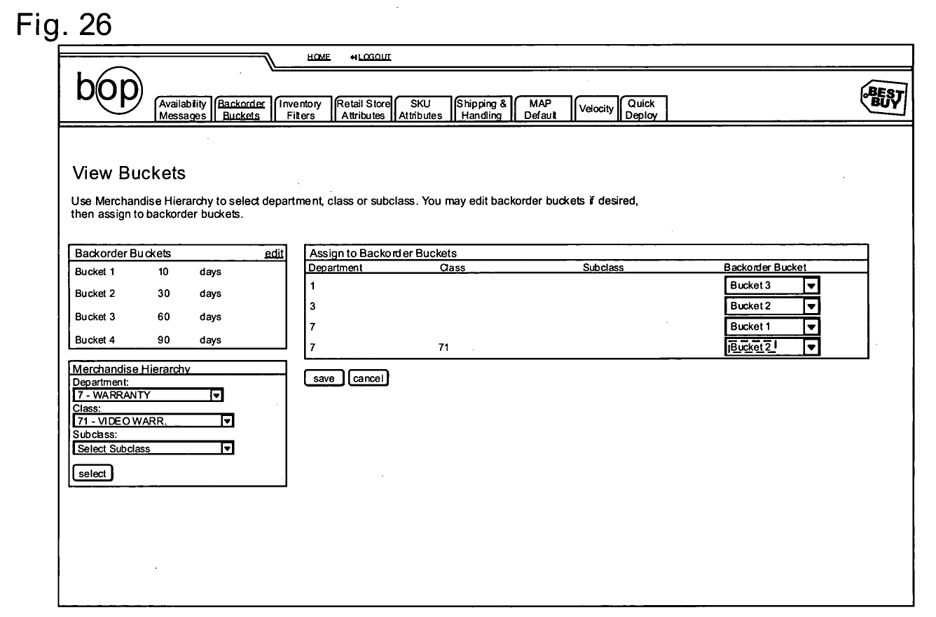

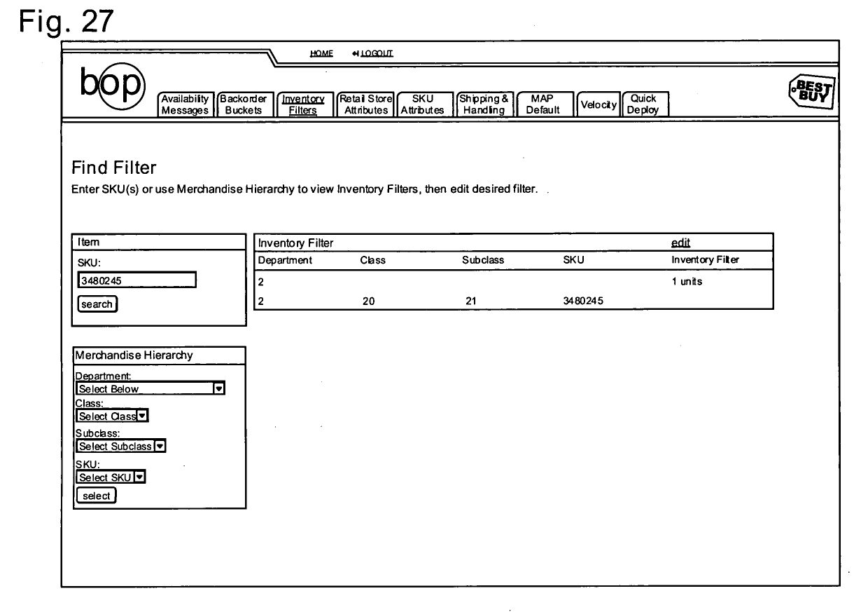

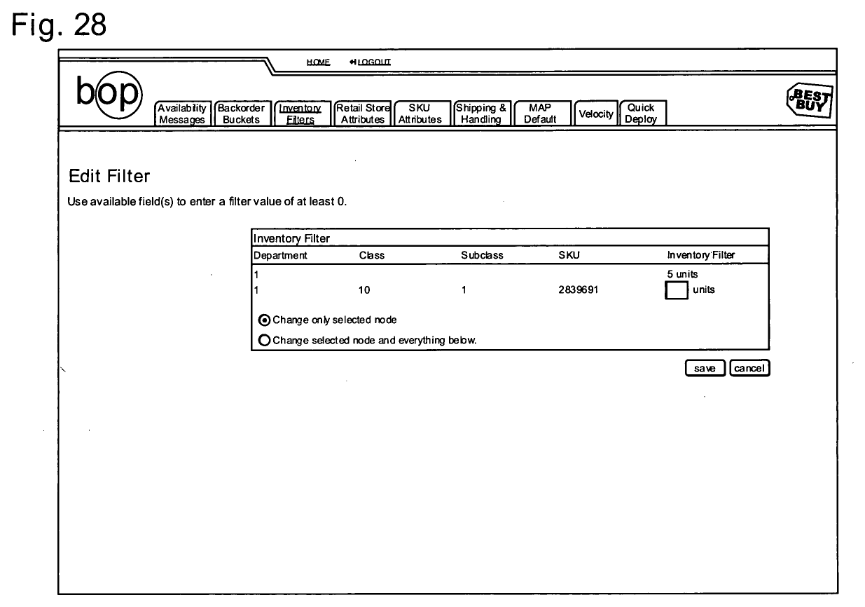

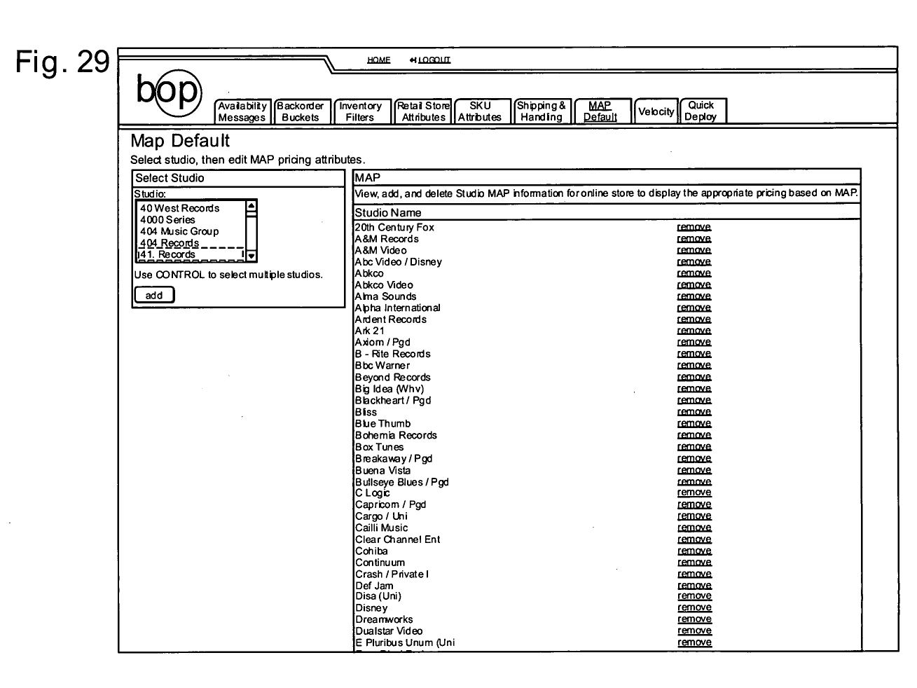

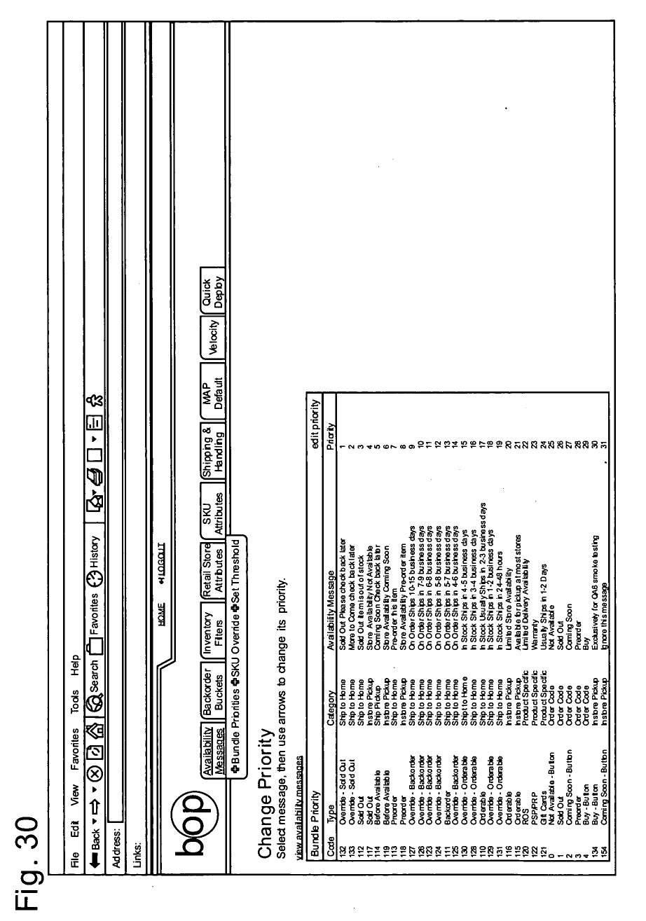

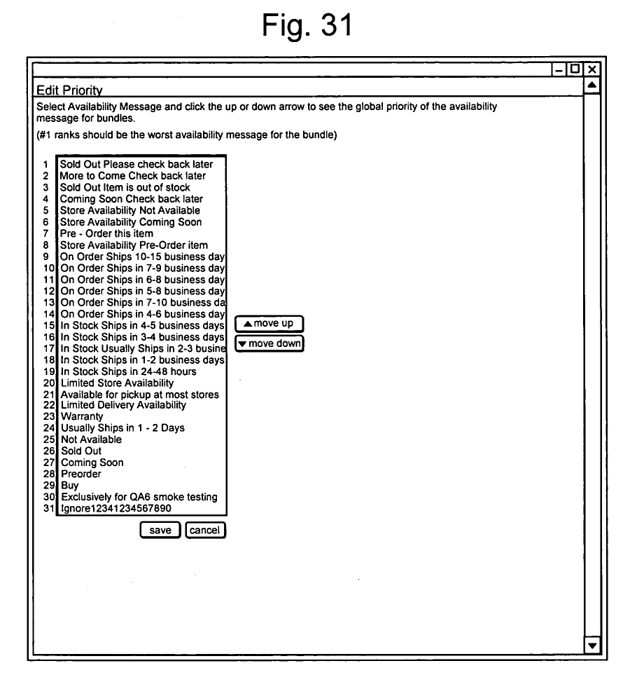

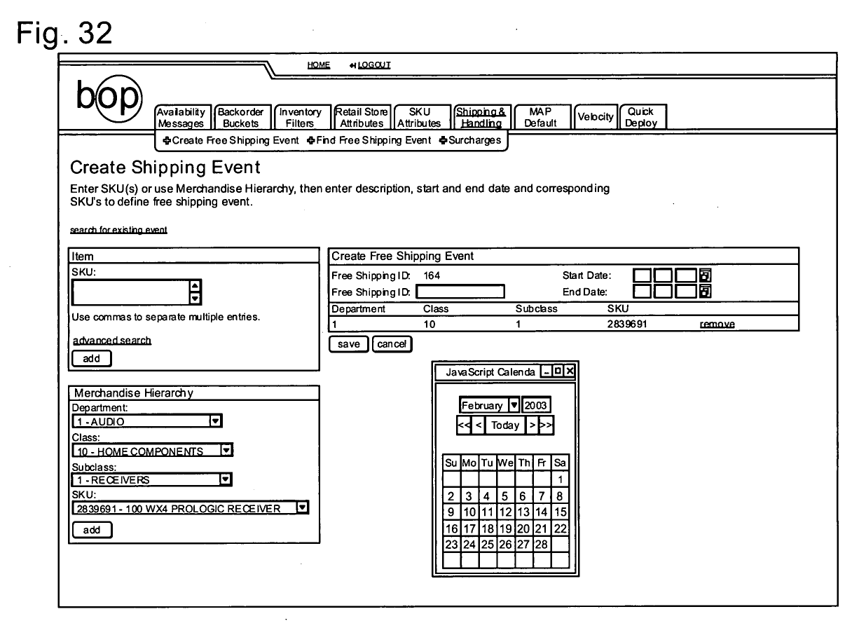

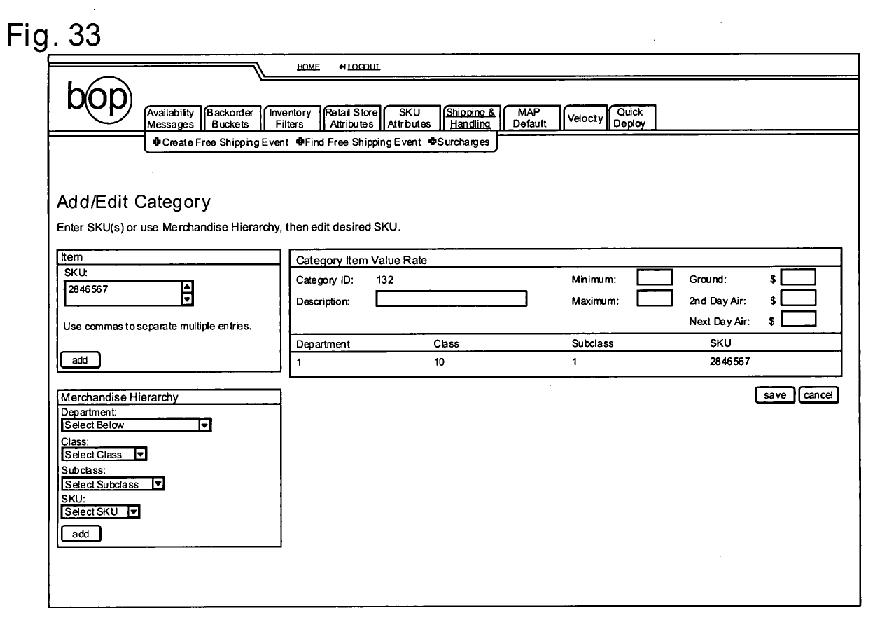

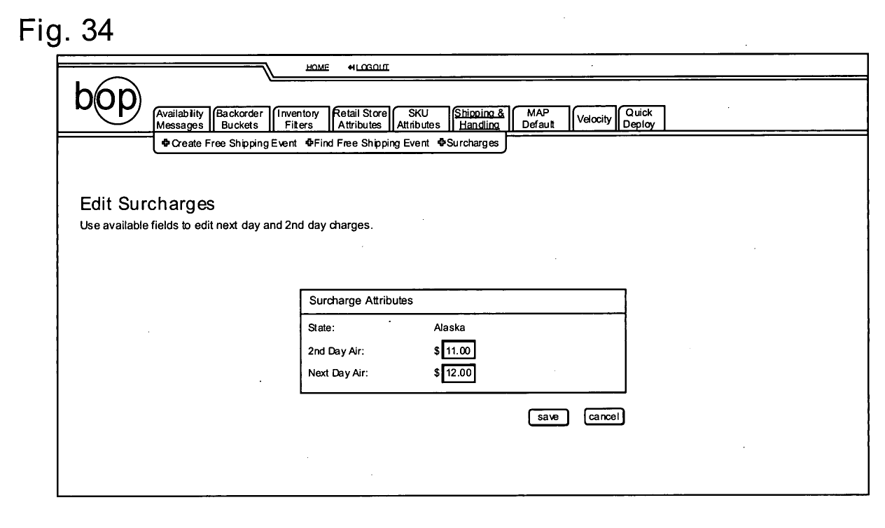

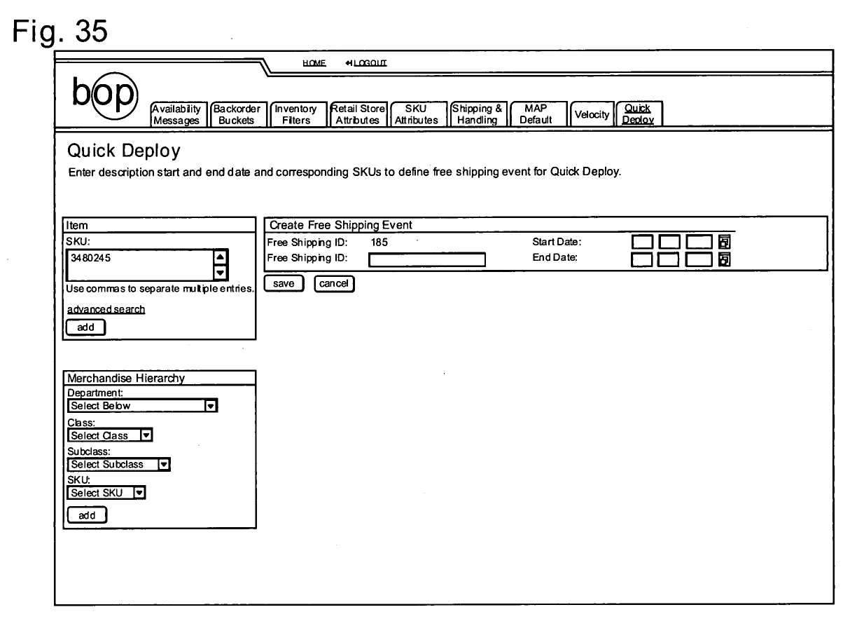

The application and database tiers 150, 151 support a web tier 162 and an image tier 163 in the MABL infrastructure component 125 and in the customer facing infrastructure 135. The web tier 162 provides basic browser access for application functionality. The image tier 163 provides a central location for images used in a business operations portal (BOP), described below with reference to FIGS. 10-35, and other applications.

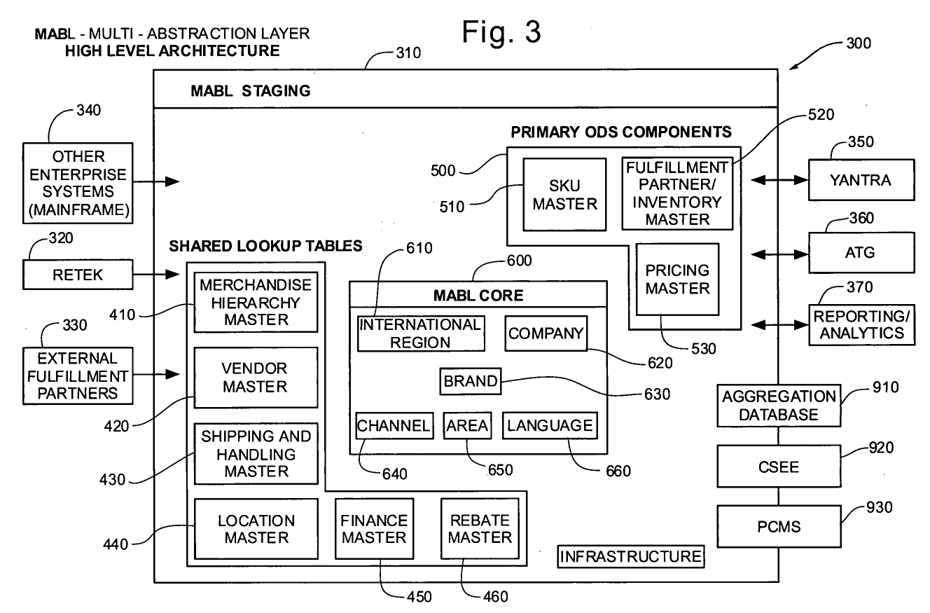

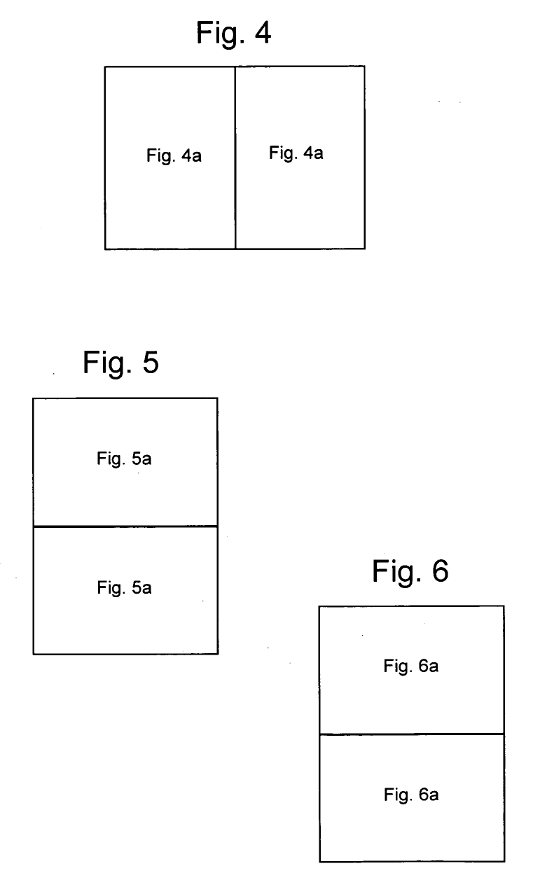

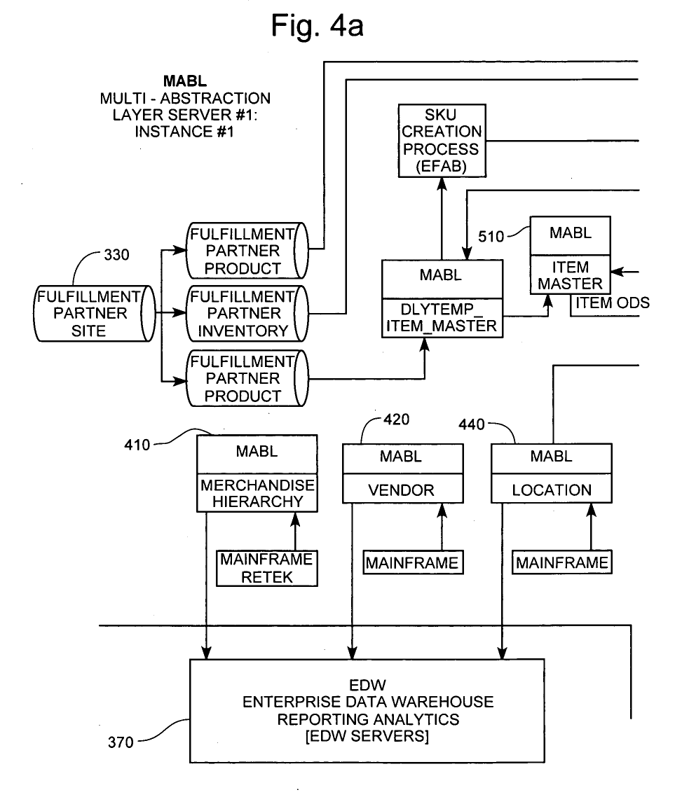

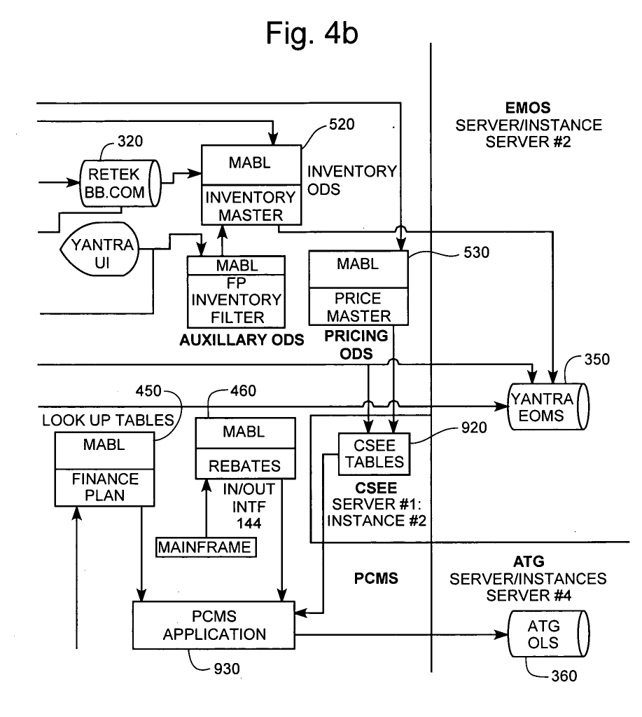

FIGS. 3 and 4 further illustrate a preferred architecture 200 for staging data for a retail business enterprise and is particularly suited for an enterprise having multiple business entities or companies, located in various international regions speaking different languages. As shown in FIG. 3, the architecture 300 includes a MABL staging system 310 that serves as a gate and routing system to process and relate multiple data sources from multiple systems, internal and external to the business enterprise. Items to the left of the staging system 310 in the diagram represent systems or databases that feed data into MABL staging system 310. More specifically, “RETEK®” 320 is an inventory management system. The inventory management system 320 supplies MABL staging system 310 with data about inventory available from the online store for product ready for immediate shipment to the customer from the distribution warehouses owned by the business enterprise or its companies. This inventory data includes such information as current and projected inventory levels for products helps establish inventory available to ship. “External fulfillment partners” or vendors 330 supply products to the enterprise and provide data regarding products and their supply to the MABL staging system 310. The enterprise operates additional systems 340 for fulfilling product orders, such as for shipping products directly to customers from warehouses and these systems 340 also provide data to the MABL staging system 310.

To the right of MABL staging system 310, as depicted in FIG. 3, are additional systems 350, 360, 370 that exchange data with MABL 310. The “YANTRA” system 350 is an order management system. The “ATG” system 360 performs functions of an on-line store such as order capture, presentation of a product catalog, site personalization and the like. The reporting and analytics system 370 generates reports and analyzes data to support management functions. Data from MABL staging 310 is used in the reports to conduct fraud investigations and order volume reports for returned and cancelled items. As depicted in FIG. 3, the MABL staging system includes shared lookup tables 400, primary operational data store components 500 and the MABL core 600. The shared lookup tables 400 serve as references for processing choices and referenced dimension hierarchies.

The shared lookup tables 400 include the merchandise hierarchy master 410 that provides a hierarchy for brands within the enterprise. For example, the tables in this hierarchy might include department, class, and subclass.

The shared lookup tables 400 further include the vendor master table 420. The vendor master table 420 is one of the sources of information for the fulfillment partner master, to be discussed below. The use of these attributes is tightly coupled with the processing related to the operational data store's fulfillment partner, inventory and SKU masters, to be described below.

Another shared lookup table 400 is the shipping and handling master table 430. Multiple tables and processes manage shipping events and categories within the MABL system. Multiple shipping events, including free shipping events, are managed by applying multiple shipping categories to SKU's. Tables contain in-process values from MABL intermediate processing tasks, or contain the end-of-process updated values for SKU shipping attributes that are used by applications outside MABL.

Yet another shared lookup table 400 is the location master table 440. The location master 440 identifies the current possible locations for all brands. The locations master table 440 stores location attributes like address and contact phone numbers for physical stores, warehouses, corporate offices and any other physical locations of the enterprise. A few attributes of the location master 440 can be managed by a user interface.

Still another shared lookup table 400 is the finance master table 450. The finance master table 450 holds a set of all finance offers offered by the enterprise. After minimal processing including branding, MABL passes this information to the Product Catalog Management System (PCMS) application.

Another shared lookup table 400 is the rebate master table 460. The rebate master table 460 holds a set of all rebates passed to MABL staging 310 from the enterprise's rebate data store. After minimal processing including branding, MABL passes this information to the PCMS application.

MABL core 600 is composed of several tables: an international region table 610; a company table 620; a brand table 630; a channel table 640; a geographic area table 650; and a language table 660. The MABL core 600 uses assignment of surrogate keys to fields in the tables to create an abstraction layer that allows each product to have a unique identifier while allowing various business entities to use their own SKU numbers. The abstraction layer provided by MABL core 600 allows ease of integration of brands, i.e. entities, as they are acquired by the enterprise. The abstraction is advantageous in such a setting because otherwise two separate brands or entities might have assigned the same SKU identifier to different products.

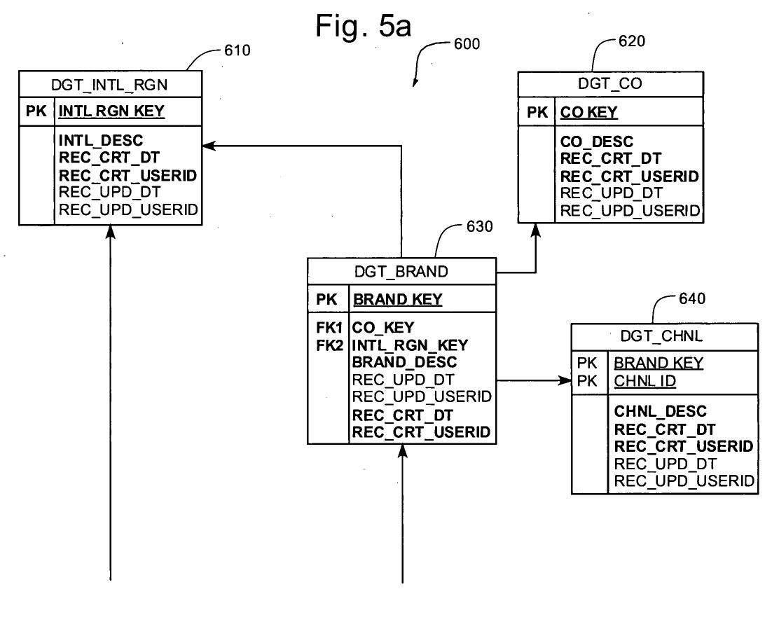

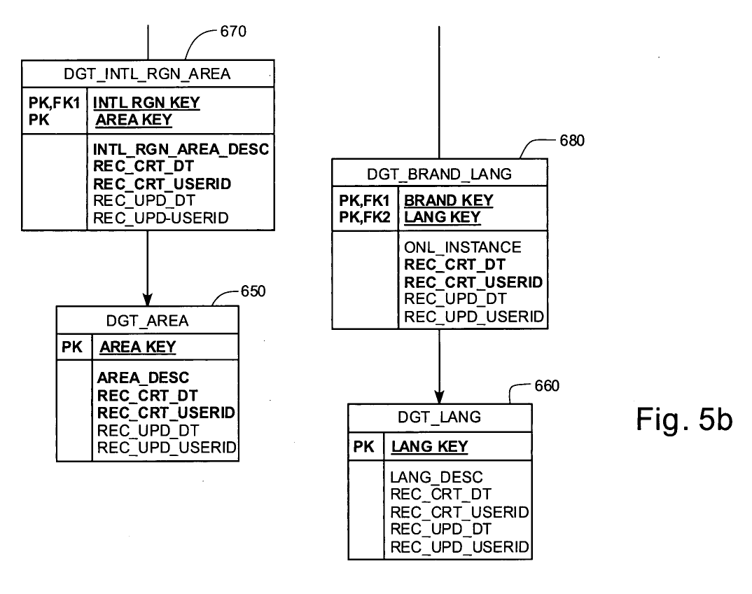

The tables 610, 620, 630, 640, 650, 660 of MABL core are depicted in FIG. 5. The brand table 630 is the parent record in the database representation which defines the brand record. Its primary key is DGT_BRAND, a sequential number generated by a number generator. The primary key depends on no other key. It is unique. Other tables will depend on the BRAND_KEY but the BRAND_KEY depends on no other attribute. Other columns could be added to the table without affecting pre-existing brands. DGT_BRAND has two other columns: INTL_RGN_KEY, which is the surrogate key of the DGT_INTL_RGN table and CO_KEY which is the surrogate key of the DGT_CO table. In FIG. 5, “PK” designates primary key and “FK” designates surrogate key. A surrogate key is a synthetic key (typically a synthetic key is numeric and generated sequentially) that is used as a substitute for natural key.

The company table 620 defines which company owns which brand. It allows for grouping of companies in a group.

The channel table 640 encompasses the way a particular brand markets products to their customers in a specific geographic region. Examples of channels include stores, internet, intranet (i.e. kiosks), handheld access (WAP) and external co-branded stores. The channel table 640 provides the ability to have shipping promotions focused by channel. Further, the channel table 640 provides an integrated suite of MABL core that support the entire retail transaction lifecycle—from informing and attracting customers, to merchandising, fulfillment and customer service. The channel table 640 creates a unified view of the customer across the entire transaction lifecycle and across all points-of-touch, including the Internet, catalogs, call center and kiosks. It enables multi-channel retailers and direct marketers to interact with, transact with and support customers in the era of e-business. The channel table 640 enhances the customer experience and improves customer relationships.

Three tables 610, 650, and 670 form the geography tables. These tables accommodate business entities or facilities in multiple countries. The DGT_AREA table 650 determines the lowest graduation of the region. DGT_AREA table 650 may house the countries of the European Economic Union (EU) while DGT_INTL_RGN table 610 houses the placeholder row “European Economic Union”. DGT_INTL_RGN_AREA is the associative table that ties the two tables together. Using this one has the ability to tie, for example, the country of France to the “European Economic Union” and at the same time to another region, say, for example, “Northern Europe”.

Two tables 660, 680 form the language tables. The language table 660, 680 functions for language as the above-described geography tables function for geography. The DGT_BRAND does not store a key for language within the DGT_BRAND table but derives language through the associative table DGT_BRAND_LANG

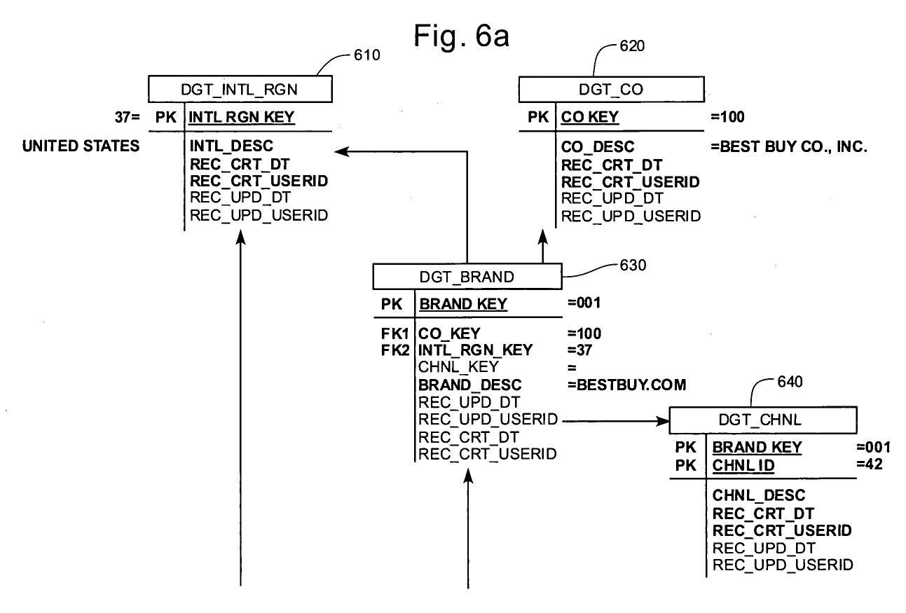

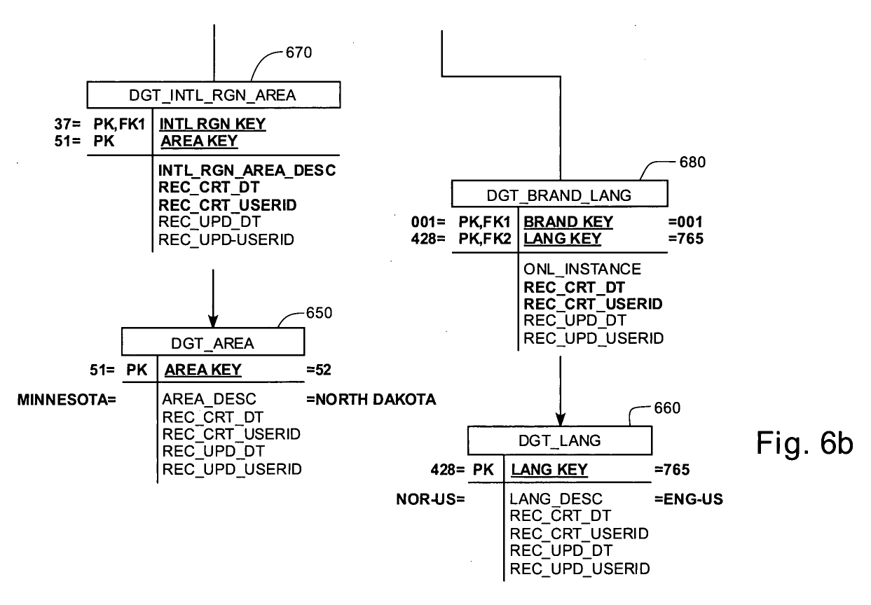

FIG. 6 shows the tables of FIG. 5 with some example data illustrated. The governing company is “Best Buy Co., Inc.”, indicated in the CO_DESC field, and it has been given a key of “100” in the CO_KEY field, as shown in the company table 620. A brand owned by Best Buy Co., Inc. is “BestBuy.com”, as indicated in the brand table 630 in field BRAND_DESC and it has been assigned a key of “001” in field BRAND_KEY. The brand delivers products through a particular channel, given a key of “42” in the CHANNEL_ID field of the channel table 640. In this example, the BestBuy.com brand operates in a region called “United States-Upper Midwest” and this region has been assigned a key of “37” which is stored in the INTL_RGN_KEY field of the International Region table 610. The region called “United States-Upper Midwest” is composed of two states: “Minnesota” which has a key of “51” and “North Dakota” which has a key of “52”; this attribute is stored in the AREA_KEY field of the DGT_AREA table 650. Within the region called “United States-Upper Midwest” there are w languages: “ENG-US” (American English) which has a key of “765” and “NOR-US” (American Norwegian) which has a key of “428”; these keys are stored in the LANG_KEY field of the DGT_LANG table 660. Each of these languages has their own ATG on-line instance denoted by the field ONL_INSTANCE.

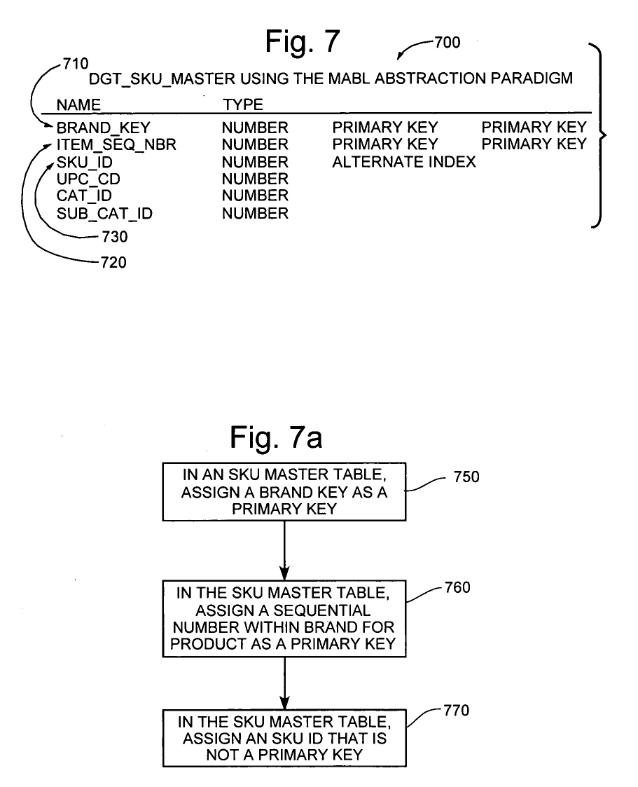

FIG. 7 represents an SKU Master Table 700 that uses the BRAND_KEY column 710 and an ITEM_SEQ_NBR column 720 as primary keys. The SKU_ID is not a primary key. Since both the BRAND_KEY 710 and the ITEM_SEQ_NBR 720 columns are meaningless and sequentially generated, there is no chance that these columns will ever need alteration. SKU_ID column 730 is a non-key column within the table structure and therefore the Master Table 700 will not be adversely impacted when alterations to the SKU_ID column are made, as often happens in a retail enterprise. The addition of an alternate index on the SKU_ID (which can be a local Oracle partition key) allows the end user to access SKU_ID without having to know any values in the primary key.

FIG. 7a presents this method of key assignment. In step 750, a brand key is assigned as a primary key in an SKU master table. In step 760, a sequential number within the brand for the product is assigned as a primary key in the SKU master table. In step 770, an SKU_ID is assigned that is not a primary key.

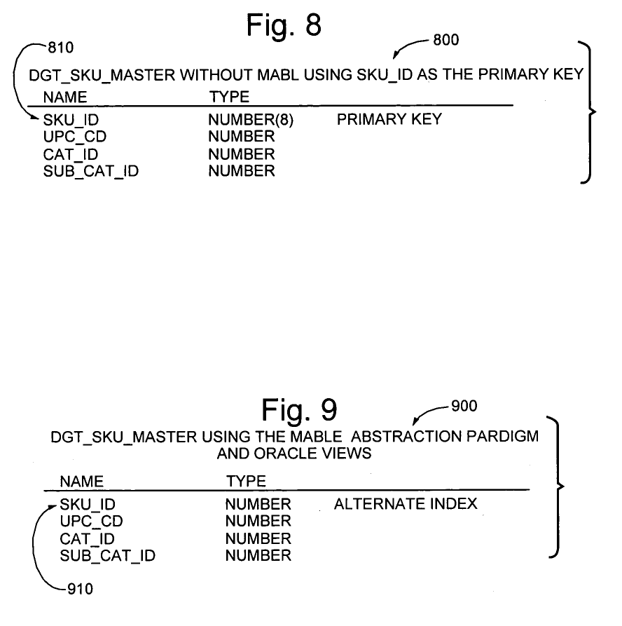

The elegance and advantages of the keying strategy illustrated in FIGS. 5, 6, 7 and 7a is apparent with reference to alternative approaches depicted in FIGS. 8 and 9. In the FIG. 8 approach, the SKU master table 800 includes a column 810 for the SKU_ID. The SKU_ID column 810 is a primary key. In this design, the primary key is tied to a column that has specific meaning but for only one portion of the enterprise. This design is vulnerable to modifications in the SKU length as sometimes occurs in business practice. If the SKU_ID changes, then the primary key must be rebuilt resulting in system outage. This design is also limited when another enterprise subsidiary begins to use the system. For example, if SKU_ID is the primary key, the system is unable to adapt if two different SKU_Ids are used for the same product or if one SKU_ID is used by different companies for different products. Even if the key were extended to allow for BRAND_KEY, then the data would still be interwoven through the table and index since SKU_ID is the lead key column. Reversing the columns to put BRAND_KEY first would only decrease the cardinality of the index. Therefore the structure 800 represented in FIG. 8 is limited in scope and resistant to change.

The structure represented in FIG. 9 is another alternative to the approach of FIG. 7. As depicted in FIG. 9, a view could be constructed over the SKU master table that shows only the data that pertains to one of the enterprise's companies. Use of this view would use the BRAND_KEY and SKU_SEQ_NBR but hide them from view. FIG. 9 shows such a view that the user could access as if there existed a table solely for a given brand. The use of an alternate index on the SKU_ID field 910 would add to this illusion. The production of these objects defeats the purpose of the abstraction layer. In addition, all batch processing must continue to use the BRAND_KEY and SKU_SEQ_NBR for accessing the SKU master table (DGT_SKU_MASTER).

With reference again to FIG. 3, the architecture 300 includes “Primary ODS Components” 500. “ODS” stands for operational data store. These components 500 facilitate the movement of the enterprise's merchandising and inventory related data into other pre-existing systems for order management and for supporting an on-line store. The table structures and processes around them insures the orderly flow of data through MABL and of moving external source data to an on-line store application system. The data movement application development method of choice for primary ODS components 500 is executed through the use of a commercially available data extraction, transformation, and loading (ETL) packaged software sold under the trademark Informatica®. The ODS data structures contain an “interface process tracking codes that specifically relate status to an external process or set of processes that must interact with MABL 310. Each external interaction process has an indicator built within the ODS whose value defines MABL process status as ongoing, as complete and ready for additional overall state of processing within MABL, i.e. when that item and its associated facts are considered “ready for use” by the Content and Product Control Management Systems, CSEE and PCMS. In other words, this control guarantees that an item is not available for use to the OLS unless it is completely assembled in all respects (including pricing, shipping & handling, and inventory) and that the EOMS has accounted for it.

The primary ODS components 500 include an SKU master table 510, a fulfillment partner/inventory master table 520 and a pricing master table 530. The pricing master 530 captures price and price event from RETEK and the subsequent calculations to determine regular and current price for an SKU and store location. In a preferred embodiment, two types of prices will be calculated in the ODS: regular price and current price, based on rules applied to price events. The ODS receives periodic, preferably hourly, updates to price events, which are held in a staging temporary table and then processed to update latest pricing to be passed out from MABL to other systems. Price event types include: regular, clearance, promotion and market reactions. If a regular price change is created, this is sent as a regular price change with a status of active. The regular price change is sent without an end date since changes such as these hold true until a new price is determined.

The inventory master table 520 captures information imported from various pre-existing systems and prepares that information for use by the order management system, YANTRA. MABL 310 processes accommodate a variety of times and data files, and “brands” the data for a specific destination. The result is to manage a timely profile of inventory available for purchase, and the possible means of getting that product to the buyer (e.g. available for in-store pickup or via shipping).

The SKU master table 510 is involved in creating a new item and in altering information about an item. The SKU master 510 carries, for example, all information related to products to be shown on a web site, such as product descriptions, UPC codes and dimensions. In processing new and existing SKU's, MABL 310 interacts with a number of other systems, including the Aggregation Database, RETEK, Item Maintenance [a.k.a. Item Scrubber] and EFAP (related to creating new items). Status column values indicate status of any interactions. The SKU master 510 also carries status indicators that relate to other ODS components' processing.

The fulfillment partner master 520 profiles potential fulfillment partners including external fulfillment partners, the enterprise's warehouses and all physical store locations. Any additions or updates to these profiles are made from the BOP portal or from updates to the Location master files. Each enterprise location is a potential fulfillment partner for in-store pick-ups.

As illustrated in FIG. 3, three components interact closely with the MABL staging system 310: the aggregation database 910, the content server (e.g. Content Server Enterprise Edition (CSEE) made by Divine) 920 and the product catalog management system (PCMS) 930. MABL 310 contains tables that will be used by and populated by processes in the aggregation database environment 910. These tables contain values used in MABL processing. MABL staging system 310 hosts a set of tables that are used by processes internal to MABL and referenced by processes outside of MABL. Updates and additions to these tables are made via a method named as “BOP Portal” (“BOP”) or “BOP Tool”. This method uses a web based user interface tool that enables business users to manipulate core commerce features. For example, merchandisers can add and delete MAP information for the studios through this tool. An example of this type of table is DGT_STUDIO_MSTR, a master table inside of MABL 310 where MAP values can be created and edited by the BOP tool which will be described below with reference to FIGS. 10-35.

FIG. 4 illustrates the flow of data between external data sources and through MABL 310.

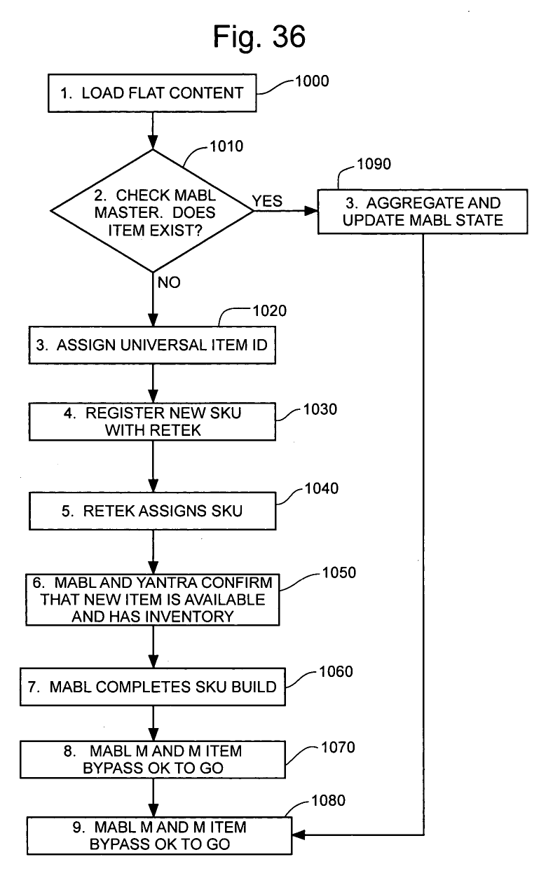

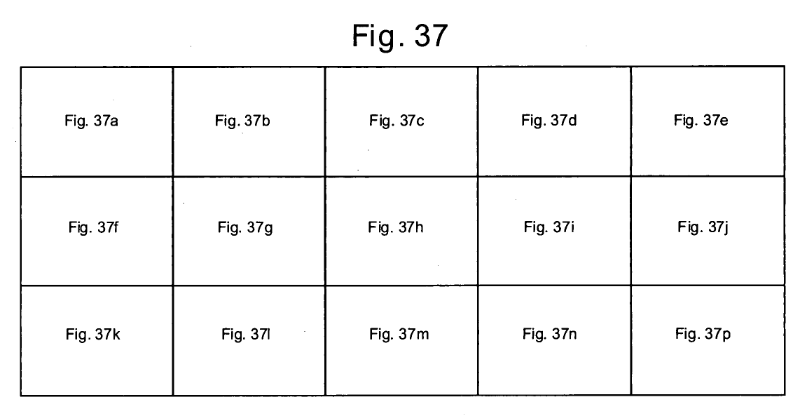

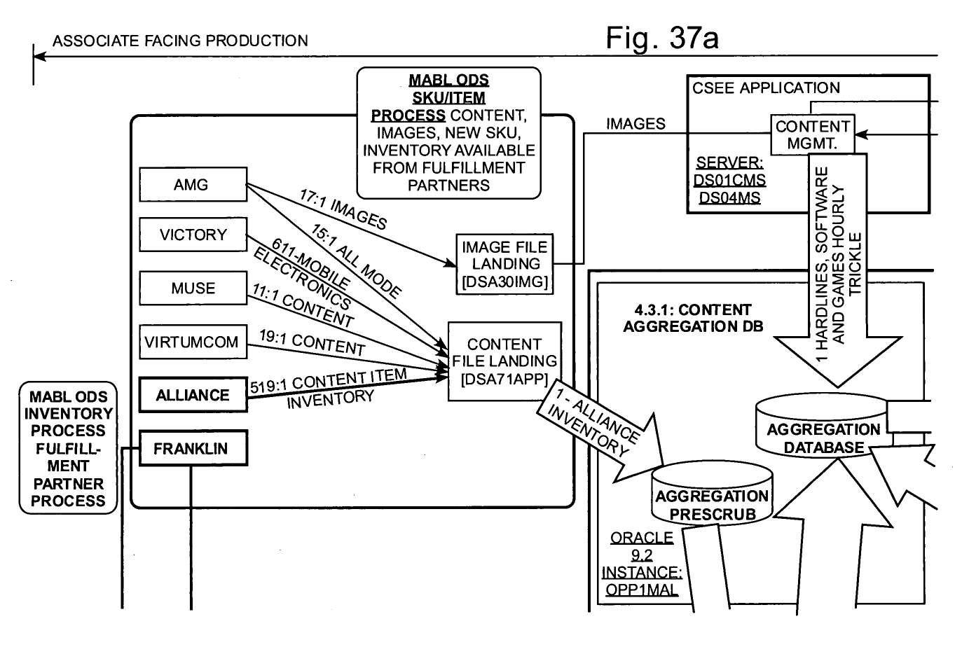

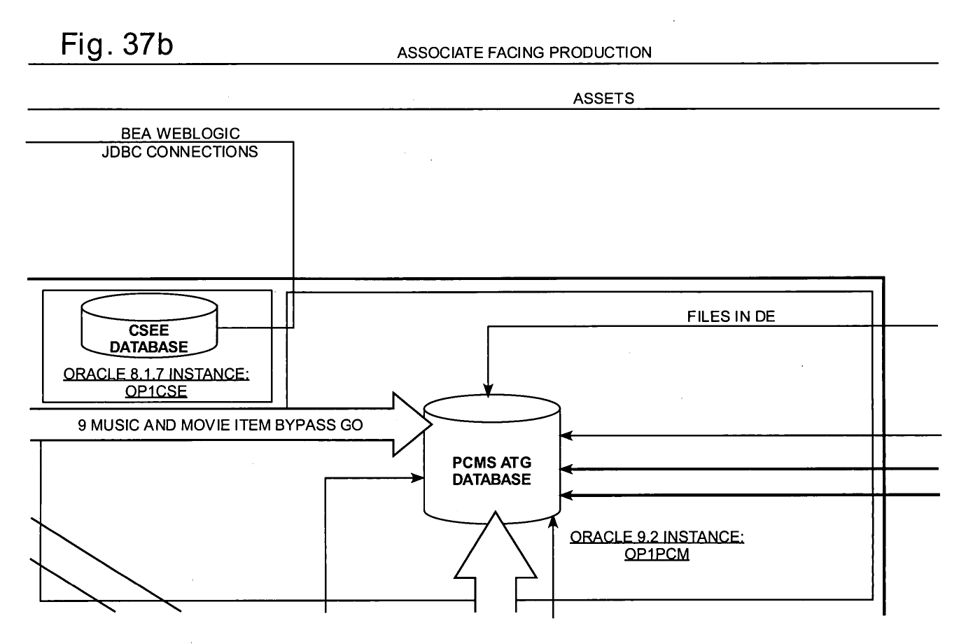

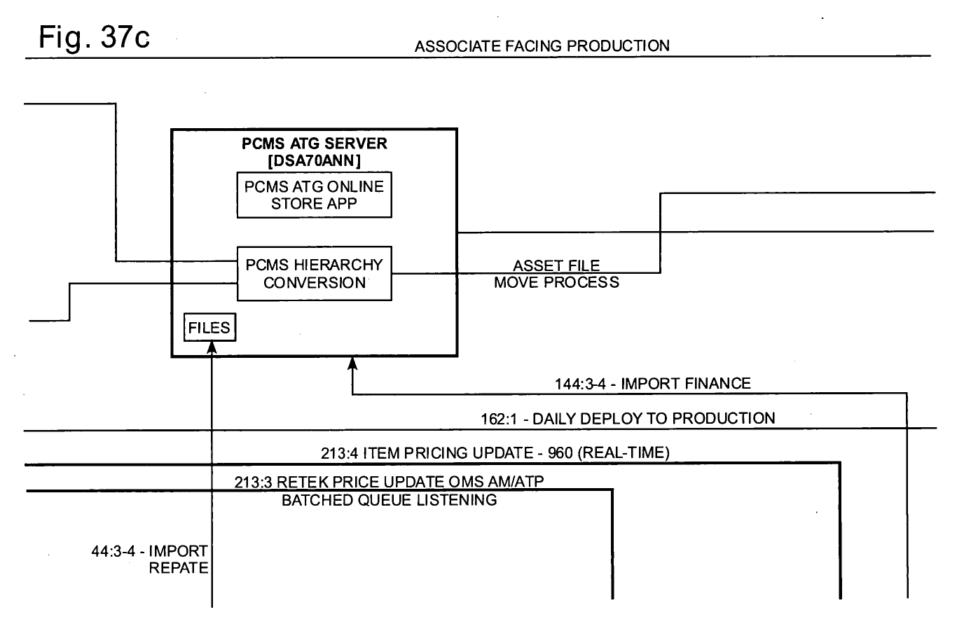

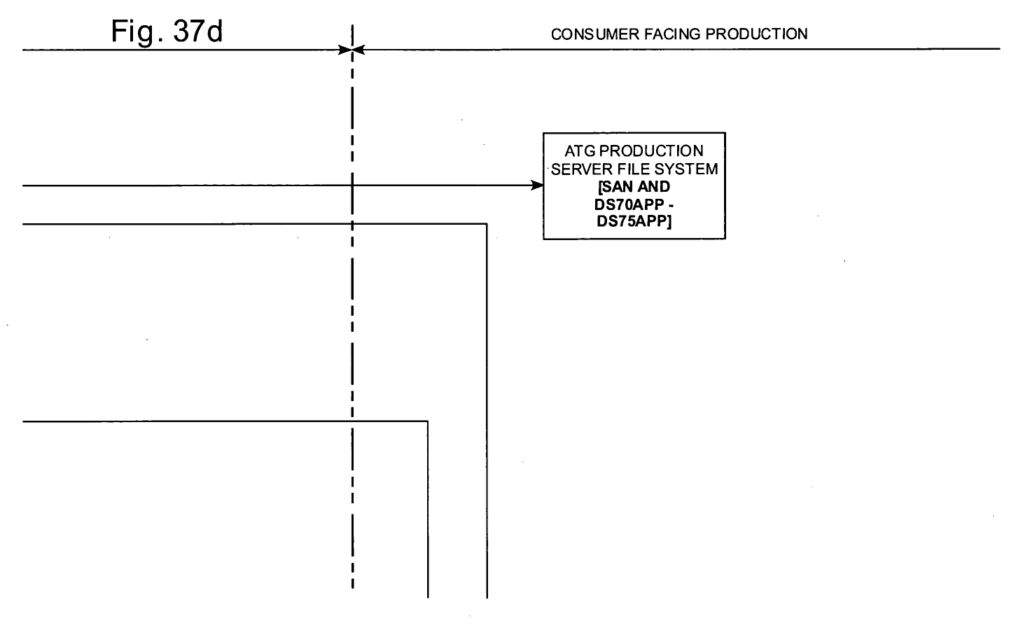

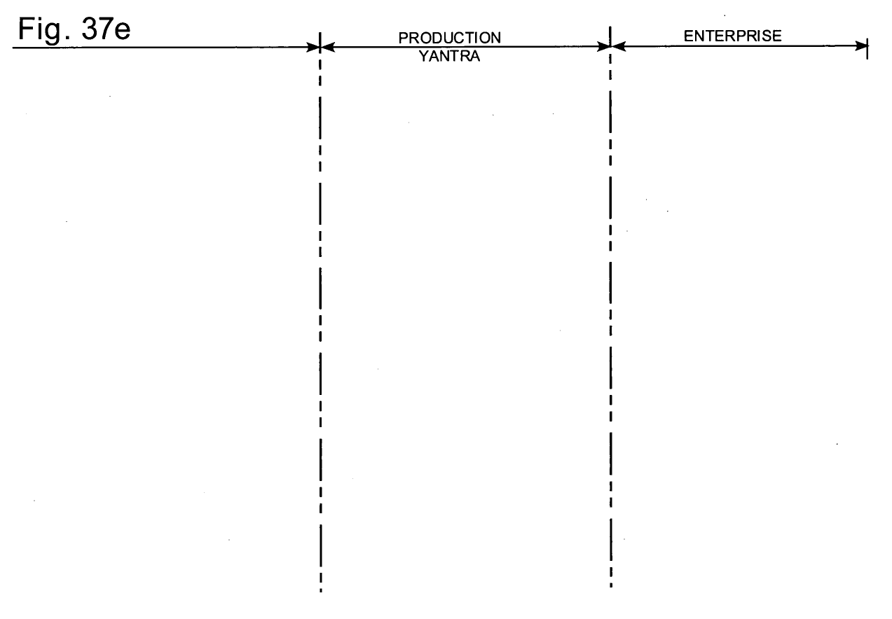

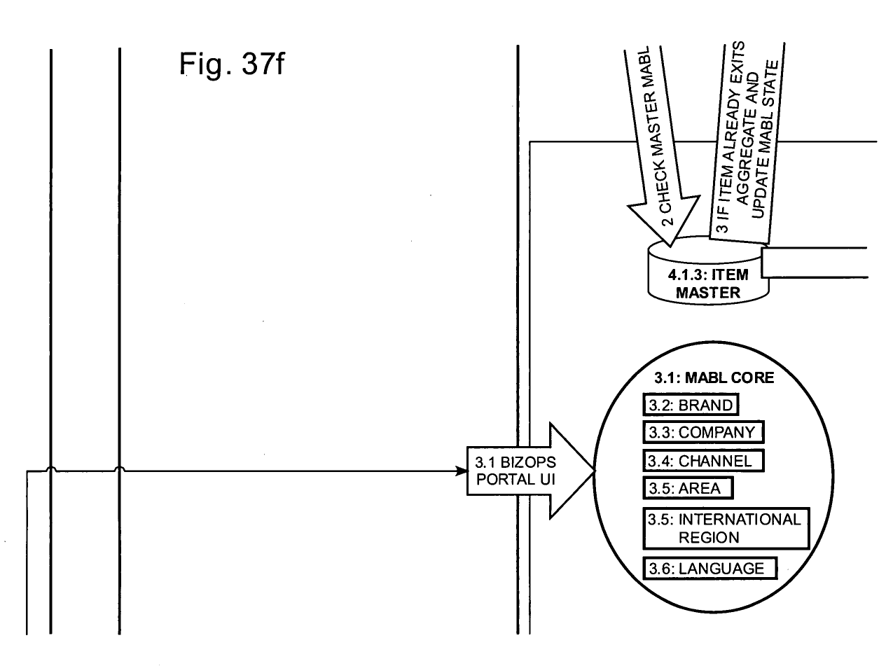

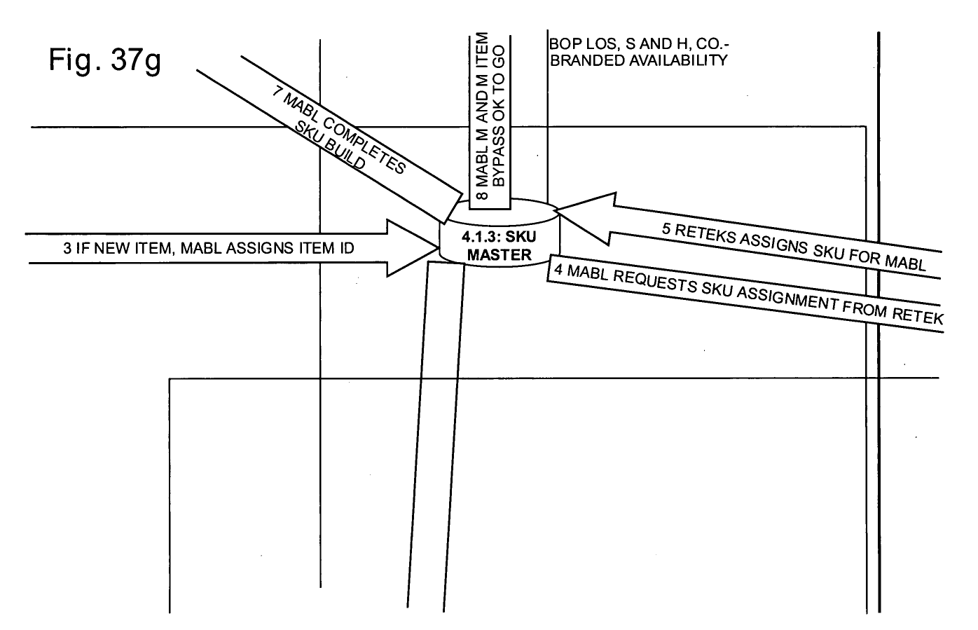

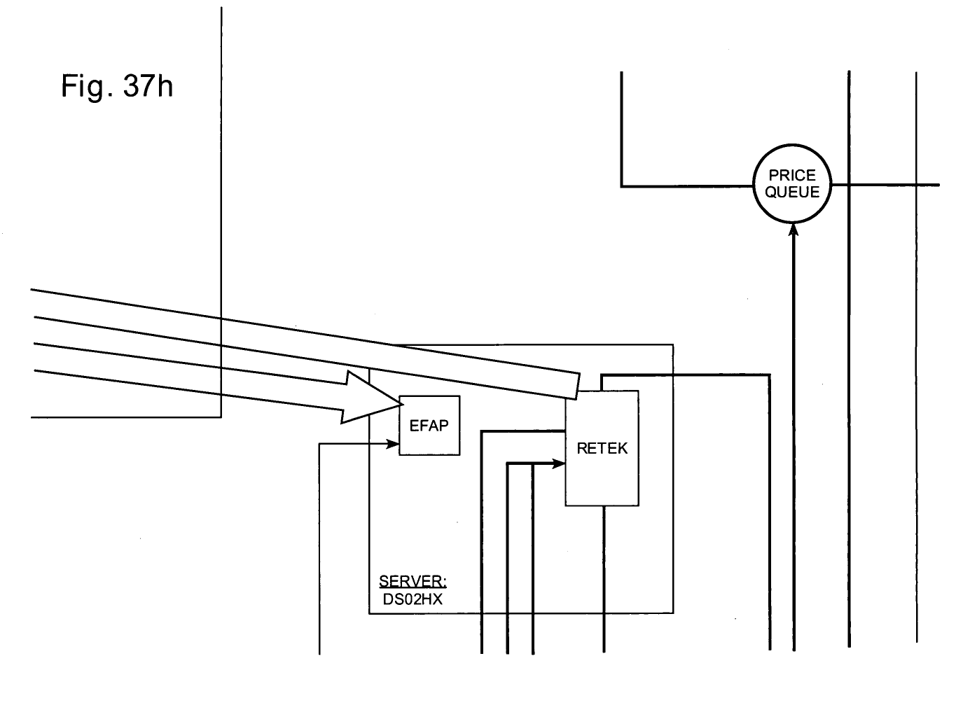

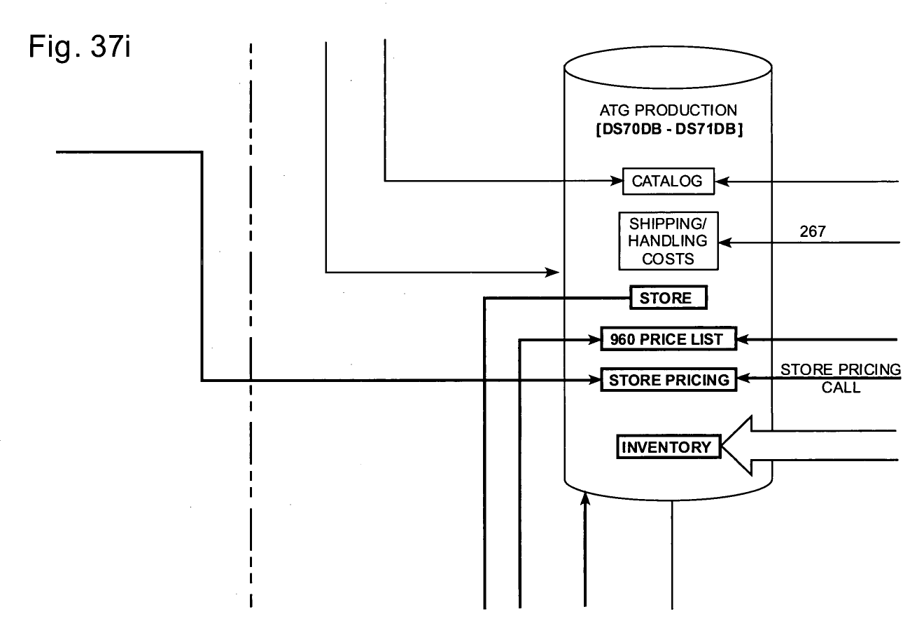

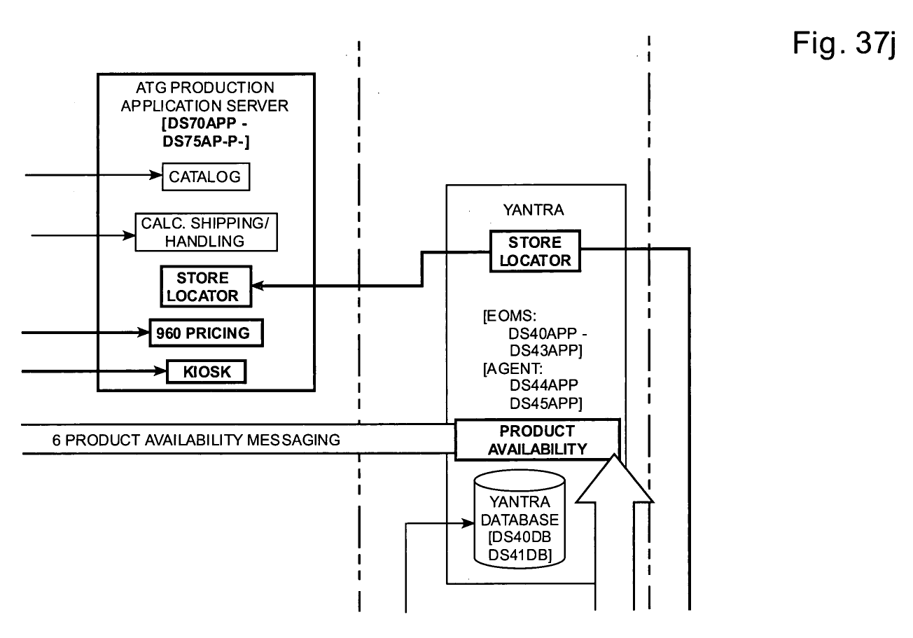

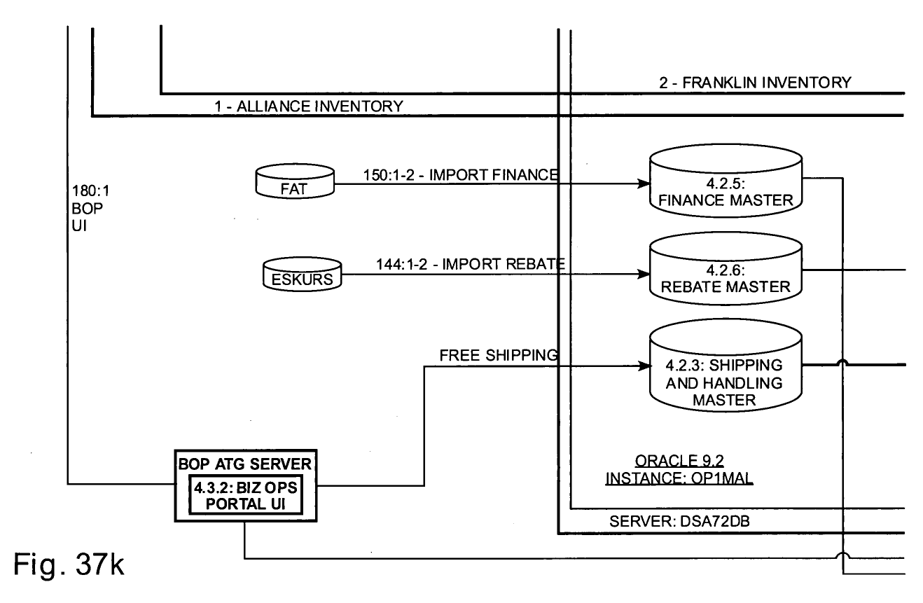

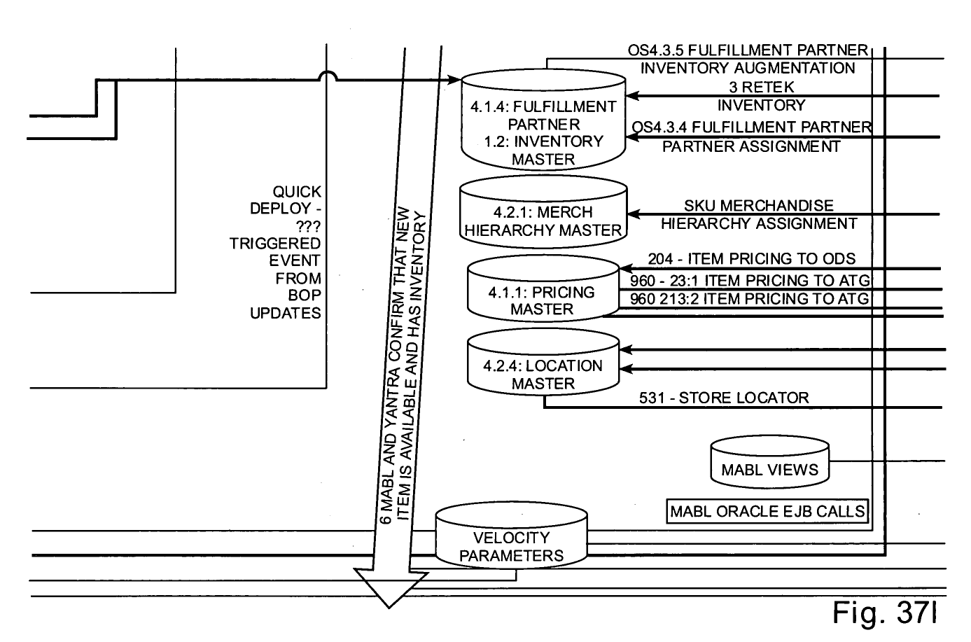

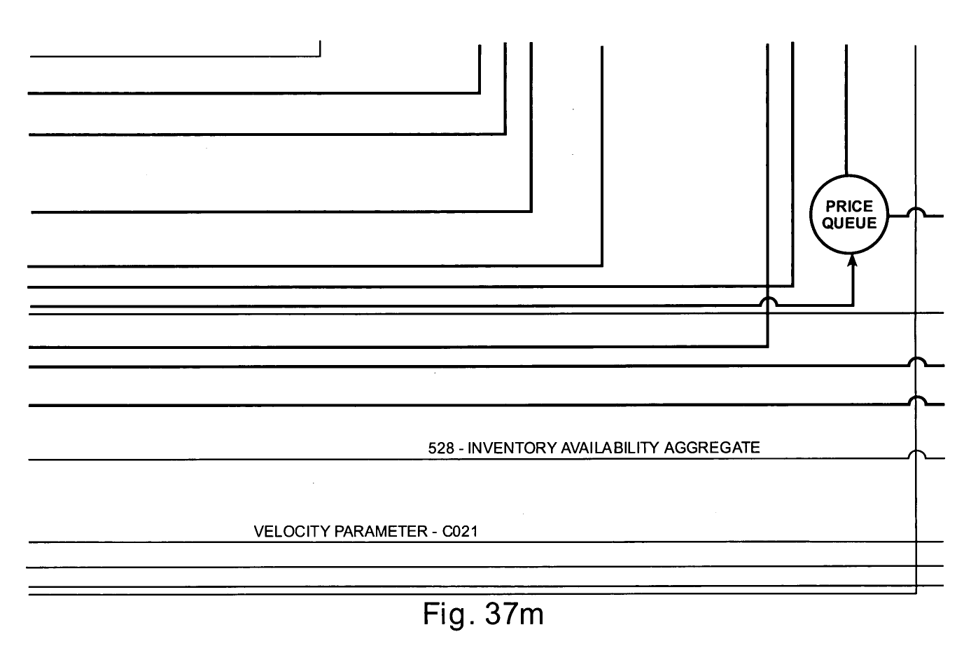

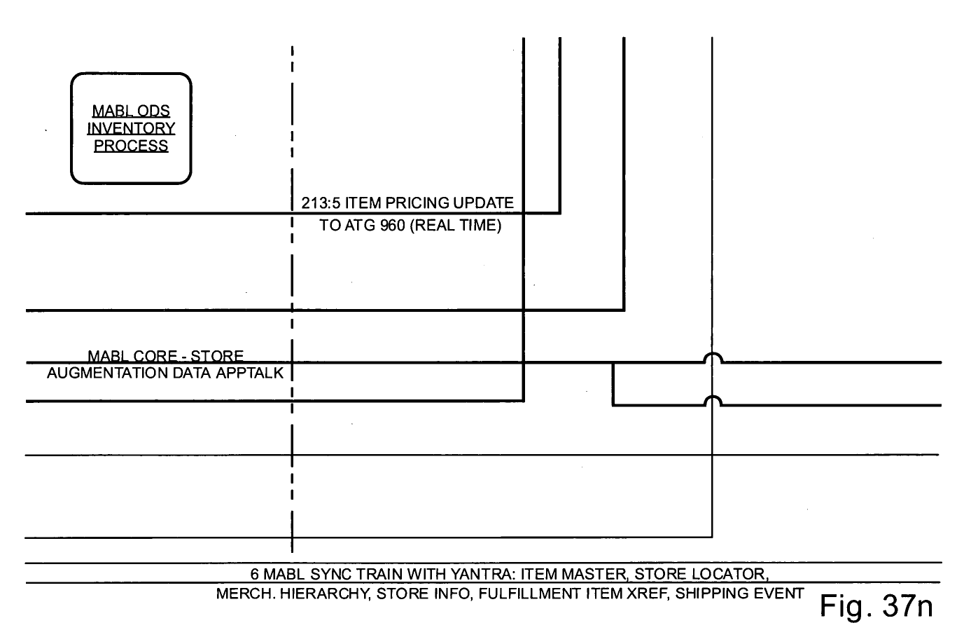

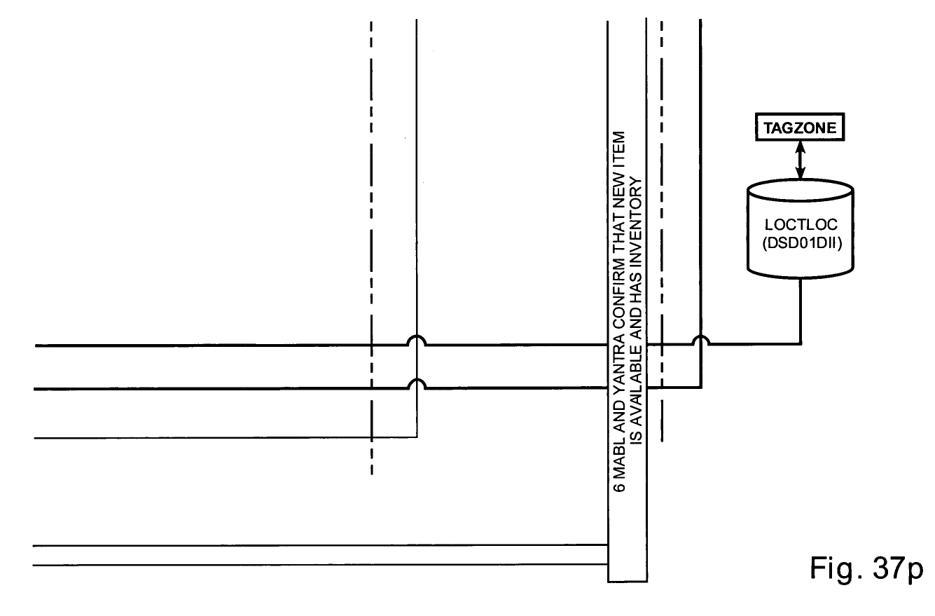

FIGS. 36 and 37 also illustrate the flow of data through the system. The numbers in FIG. 36 correspond to the numbers located within the wide arrows in FIG. 37. In step 1000, fulfillment partners to the enterprise provide content, images and in some cases SKU numbers and SKU inventory. This content is received in an aggregation pre-scrub database. This process stages the content and image files for rendering and distribution to the CSEE asset management system and the PCMS ATG Store preview package. Eventually the content and images are shipped to the ATG Online Store.

In step 1010, the item master is checked to determine whether the item already exists. If the item does not exist, MABL inaugurates the Item/SKU creation process (1020). This process ties various vendor UPC codes to the enterprise's SKU. Subsequent steps continue profiling the Item/SKU creation process. MABL then assigns a universal production ID which the program denotes as an “ITEM_ID”. In this way, MABL manages having the SKU manifested by different fulfillment partners while MABL also allows reconciliation of SKUs across Best Buy subsidiaries. (For example, SKU 234 at Subsidiary A may be the same product as SKU 456 at Subsidiary B, but both SKU records have the same ITEM_ID.)

In step 1030, the MABL system requests an SKU assignment from RETEK. RETEK provide enterprise-specific SKU details to register the new SKU.

In step 1040, RETEK sends MABL the enterprise-specific SKU details to map the fulfillment partner SKU to the enterprise SKU.

In step 1050, before the new SKU appears available to customers, the YANTRA order management system must be prepared to take orders for the new SKU. This asynchronous process registers the new SKU with YANTRA, and YANTRA indicates to the ATG Online Store that the SKU is ready to be offered to customers once final confirmation is propagated by MABL.

In step 1060, MABL notifies the aggregation database that the SKU build is complete and remaining processes can proceed.

In step 1070, MABL indicates that the music and movies feed is OK to go to PCMS.

In step 1080, MABL indicates that the aggregation database may send the music and movies feed to PCMS.

If, at step 1010, MABL determines that the item already exists, then MABL records that some item attributes may have changed and aggregates and updates the MABL state (1090). Consequently, the Item/SKU should be reprocessed as part of the next batch update by broadcasting to the downstream PCMS, ATG and YANTRA systems. MABL then indicates that the aggregation database may send the music and movies feed to PCMS.

As noted above, it is particularly advantageous that the flow of data through the system be automated and further that the process flow be flexible to allow it to be altered in response to changing business rules. This automation is accomplished by a system of state flags that are “switched” in response to events occurring in the data process flow. These events and the resulting state flag switches are illustrated in FIGS. 38-45.

Authorized personnel of the enterprise have the ability to create and alter business rules, which affect the data process flow, and to view and interact with data shepherded by MABL. As noted above, a user interface 2000, “the BOP tool”, for allowing personnel to view, interact with, set rules for the MABL system 310 is illustrated in FIGS. 10-35. The BOP tool allows selected employees of the enterprise to set business rule sets which control data processes in MABL 310. Some users of the BOP tool include those responsible for managing inventory; those responsible for purchasing entertainment media; those responsible for managing the transportation of inventory; fraud analysts and those responsible for administrating the BOP tool. Each group is provided access to select features and content appropriate to their areas of responsibility and is allowed editing to select varying degrees.

Some of the tasks that can be accomplished via BOP tool are as follows:

Availability Messaging (bundle priorities, override an SKU assignment, set thresholds for inventory)

Manage availability messages

Assign “backorder buckets” to department, class or subclass

View and edit inventory filters

View attributes of retail stores

View and edit SKU attributes

Create and find free shipping events

Set fraud velocity settings

Set Product MAP default assignments

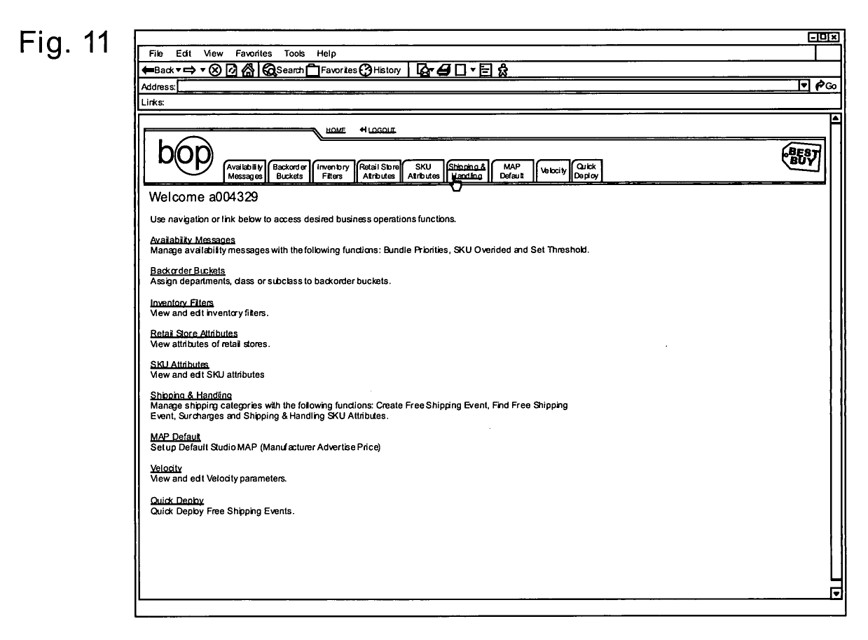

FIGS. 11-35 is screen shots which show tasks that can be performed via the BOP portal.

Although an illustrative version of the invention is shown, it should be clear that many modifications may be made without departing from the scope of the invention.

It is claimed:

1. A method for establishing an abstraction layer in a database representing items offered for sale in an enterprise having more than one brand through which items are sold, comprising the steps of:
a) establishing an SKU master table having columns for a brand identifier, a sequential number identifier for the product and an SKU identifier;
b) setting said brand identifier as a primary key;
c) setting said sequential number identifier as a primary key; and
d) not setting said SKU identifier as a primary key.

2. The method according to claim 1, further comprising the step of:
e) setting said SKU ID as an alternate index.
